(19) United States
(12) Patent Application Publication
(10) Pub. No.: US 2013/0154911 A1
(43) Pub. Date: Jun. 20, 2013

(54) DISPLAY DEVICE AND ELECTRONIC DEVICE

(71) Applicants: INNOCOM TECHNOLOGY CO., LTD, Shenzhen City (CN); CHIMEI INNOLUX CORPORATION, Chu-Nan (TW)

(72) Inventors: Chien-Hung CHEN, Chu-Nan (TW); Yu-Wei CHEN, Chu-Nan (TW)

(73) Assignees: CHIMEI INNOLUX CORPORATION, Chu-Nan (TW); INNOCOM TECHNOLOGY CO., LTD, Shenzhen City (CN)

(21) Appl. No.: 13/720,246

(22) Filed: Dec. 19, 2012

(30) Foreign Application Priority Data
Dec. 20, 2011 (TW) 100147279

(51) Int. Cl. G02F 1/1343; G09G 3/36

(52) U.S. Cl. CPC G02F 1/134336; G09G 3/36
USPC 345/87; 349/144

(57) ABSTRACT

A display device includes a first, second and third sub-pixel areas allowing light of a first, second and third main wavelengths transmitting therethrough, respectively. The first, second and third sub-pixel areas have first, second and third ratios of first, second and third electrode widths to first, second and third electrode slits of first, second and third interdigitated electrodes, respectively. When the first main wavelength is larger than the second main wavelength and the second main wavelength is larger than the third main wavelength, a difference between any two of the first, second and third ratios is less than 0.2. A first electrode slit of the first interdigitated electrode is smaller than the second electrode slit of the second interdigitated electrode, and the second electrode slit of the second interdigitated electrode is smaller than the third electrode slit of the third interdigitated electrode.

### CROSS REFERENCE TO RELATED APPLICATIONS

This application claims priority of Taiwan Patent Application No. 100147279, filed on Dec. 20, 2011, the entirety of which is incorporated by reference herein.

### BACKGROUND OF THE INVENTION

1. Field of the Invention

The present invention relates to a display device, and in particular, to a display device with low dispersion.

2. Description of the Related Art

A blue phase liquid crystal (BPLC) has advantages of having a fast response time, and being free of an alignment layer. Also, the BPLC is optically isotropic. Therefore, the BPLC shows an ideal dark state.

Birefringence dispersion (Δn) of the conventional LC is expressed by using the Cauchy dispersion formula (Formula (1))

$$Δ n \sim \frac{3 GS}{2} \frac{{λ}^{2} {λ}^{* 2}}{{λ}^{2} - {λ}^{* 2}} , \qquad formula ( 1 )$$

wherein G is proportionality constant, S is order parameter and λ* is mean resonance wavelength.

Macroscopically, birefringence dispersion (Δn) of the BPLC is expressed by using the Kerr effect formula (Formula (2))

$$Δ n \sim λ K {E}^{2} , λ K \sim G \frac{{λ}^{2} {λ}^{* 2}}{{λ}^{2} - {λ}^{* 2}} , \qquad formula ( 2 )$$

wherein E is electric field strength, G is proportionality constant, S is order parameter and λ* is mean resonance wavelength.

Additionally, birefringence dispersion of the BPLC is affected by the local electric field strength. Further, a direction of an applied electric field approximates a direction of an effective optical axis. Therefore, the BPLC has the maximum birefringence when the electric field is vertical to a direction of incident light. For design of sub-pixels having the same structure, operation voltage-transmittance curves (V-T curves) of different sub-pixels show different dispersion degrees. FIG. 1 is an operation voltage-transmittance curve diagram corresponding to a red sub-pixel area (650±30 nm), a green sub-pixel area (550±30 nm) and a blue sub-pixel area (450±30 nm) of the conventional blue phase liquid crystal (BPLC) display device, showing a dispersion effect of the conventional BPLC display. As shown in FIG. 1, V-T curves of the different sub-pixel areas of the conventional BPLC display device show bad overlapping degrees (do not match together). Thus, the conventional BPLC display has a serious dispersion problem. Also, the conventional BPLC display has a color shift problem at different viewing-angles.

Thus, a novel BPLC display device with reduced dispersion to improve the color shift problem is desired.

### BRIEF SUMMARY OF INVENTION

A display device is provided. An exemplary embodiment of a display device comprises a first sub-pixel area allowing a light of a first main wavelength transmitting therethrough. A second sub-pixel area allows a light of a second main wavelength transmitting therethrough. A third sub-pixel area allows a light of a third main wavelength transmitting therethrough. A first interdigitated electrode is disposed in the first sub-pixel area, having first electrode strips parallel to each other, wherein the first electrode strips have a first electrode width and a first electrode slit, and wherein the first sub-pixel area has a first ratio of the first electrode width and the first electrode slit of the first electrode strips. A second interdigitated electrode is disposed in the second sub-pixel area, having second electrode strips parallel to each other, wherein the second electrode strips have a second electrode width and a second electrode slit, and wherein the second sub-pixel area has a second ratio of the second electrode width and the second electrode slit of the second electrode strips. A third interdigitated electrode is disposed in the third sub-pixel area, having third electrode strips parallel to each other, wherein the third electrode strips have a third electrode width and a third electrode slit, and wherein the third sub-pixel area has a third ratio of the third electrode width and the third electrode slit of the third electrode strips. When the first main wavelength is larger than the second main wavelength and the second main wavelength is larger than the third main wavelength, a difference between any two of the first, second and third ratios is less than 0.2. Also, the first electrode slit is smaller than the second electrode slit, and the second electrode slit is smaller than the third electrode slit.

Another exemplary embodiment of a display device comprises a first sub-pixel area allowing a light of a first main wavelength transmitting therethrough has a first cell gap. A second sub-pixel area allowing a light of a second main wavelength transmitting therethrough has a second cell gap. A third sub-pixel area allowing a light of a third main wavelength transmitting therethrough has a third cell gap. A first interdigitated electrode is disposed in the first sub-pixel area, having first electrode strips parallel to each other, wherein the first electrode strips have a first electrode width and a first electrode slit, and wherein the first sub-pixel area has a first ratio of the first electrode width and the first electrode slit of the first electrode strips. A second interdigitated electrode is disposed in the second sub-pixel area, having second electrode strips parallel to each other, wherein the second electrode strips have a second electrode width and a second electrode slit, and wherein the second sub-pixel area has a second ratio of the second electrode width and the second electrode slit of the second electrode strips. A third interdigitated electrode is disposed in the third sub-pixel area, having third electrode strips parallel to each other, wherein the third electrode strips have a third electrode width and a third electrode slit, and wherein the third sub-pixel area has a third ratio of the third electrode width and the third electrode slit of the third electrode strips. When the first main wavelength is larger than the second main wavelength and the second main wavelength is larger than the third main wavelength, a difference between any two of the first, second and third ratios is less than 0.2. Also, the first cell gap is larger than the second cell gap and the second cell gap is larger than third cell gap.

Yet another exemplary embodiment of an electronic device comprises a display device comprising a first sub-pixel area allowing a light of a first main wavelength transmitting therethrough. A second sub-pixel area allows a light of a second main wavelength transmitting therethrough. A third sub-pixel area allows a light of a third main wavelength transmitting therethrough. A first interdigitated electrode is disposed in the first sub-pixel area, having first electrode strips parallel to each other, wherein the first electrode strips have a first electrode width, a first electrode slit and a first electrode height, and wherein the first sub-pixel area has a first ratio of the first electrode width to the first electrode slit of the first electrode strips. A second interdigitated electrode is disposed in the second sub-pixel area, having second electrode strips parallel to each other, wherein the second electrode strips have a second electrode width, a second electrode slit and a second electrode height, and wherein the second sub-pixel area has a second ratio of the second electrode width to the second electrode slit of the second electrode strips. A third interdigitated electrode is disposed in the third sub-pixel area, having third electrode strips parallel to each other, wherein the third electrode strips have a third electrode width, a third electrode slit and a third electrode height, and wherein the third sub-pixel area has a third ratio of the third electrode width to the third electrode slit of the third electrode strips. When the first main wavelength is larger than the second main wavelength and the second main wavelength is larger than the third main wavelength, a difference between any two of the first, second and third ratios is less than 0.2. Also, the first electrode height is larger than the second electrode height and the second electrode height is larger than third electrode height.

Still yet another exemplary embodiment of an electronic device comprises a display device comprising a first sub-pixel area allowing a light of a first main wavelength transmitting therethrough has a first cell gap. A second sub-pixel area allowing a light of a second main wavelength transmitting therethrough has a second cell gap. A third sub-pixel area allowing a light of a third main wavelength transmitting therethrough has a third cell gap. A first interdigitated electrode is disposed in the first sub-pixel area, having first electrode strips parallel to each other, wherein the first electrode strips have a first electrode width and a first electrode slit, and wherein the first sub-pixel area has a first ratio of the first electrode width and the first electrode slit of the first electrode strips. A second interdigitated electrode is disposed in the second sub-pixel area, having second electrode strips parallel to each other, wherein the second electrode strips have a second electrode width and a second electrode slit, and wherein the second sub-pixel area has a second ratio of the second electrode width and the second electrode slit of the second electrode strips. A third interdigitated electrode is disposed in the third sub-pixel area, having third electrode strips parallel to each other, wherein the third electrode strips have a third electrode width and a third electrode slit, and wherein the third sub-pixel area has a third ratio of the third electrode width and the third electrode slit of the third electrode strips. When the first main wavelength is larger than the second main wavelength and the second main wavelength is larger than the third main wavelength, a difference between any two of the first, second and third ratios is less than 0.2. Also, the first electrode slit is smaller than the second electrode slit, and the second electrode slit is smaller than the third electrode slit. Alternatively, when the first main wavelength is larger than the second main wavelength and the second main wavelength is larger than the third main wavelength, a difference between any two of the first, second and third ratios is less than 0.2. Also, the first cell gap is larger than the second cell gap and the second cell gap is larger than third cell gap. Alternatively, when the first main wavelength is larger than the second main wavelength and the second main wavelength is larger than the third main wavelength, a difference between any two of the first, second and third ratios is less than 0.2. Also, the first electrode height is larger than the second electrode height and the second electrode height is larger than third electrode height. A controller controls the display device such that the display device displays images.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is an operation voltage-transmittance curve diagram corresponding to a red sub-pixel area (650±30 nm), a green sub-pixel area (550±30 nm) and a blue sub-pixel area (450±30 nm) of the conventional blue phase liquid crystal (BPLC) display device, showing a dispersion effect of the conventional BPLC display.

FIGS. 2a and 2b are respectively a top view and a cross sectional view taken along line A-A′ of FIG. 2a showing one exemplary embodiment of a display device of the invention.

FIGS. 3a and 3b are respectively a top view and a cross sectional view taken along line A-A′ of FIG. 3a showing one exemplary embodiment of a display device of the invention.

FIG. 4 is an operation voltage-transmittance curve comparison diagram of the conventional BPLC display device and a BPLC display device according to one exemplary embodiment of the invention, showing that the different sub-pixel areas of the BPLC display according to one exemplary embodiment of the invention have different ratios of electrode width to electrode slit.

FIG. 5 is an operation voltage-transmittance curve comparison diagram of the conventional BPLC display device and a BPLC display device according to another exemplary embodiment of the invention, showing that the different sub-pixel areas of the BPLC display according to one exemplary embodiment of the invention have different cell gaps.

FIG. 6 is an operation voltage-transmittance curve comparison diagram of the conventional BPLC display device and a BPLC display device according to yet another exemplary embodiment of the invention, showing that the different sub-pixel areas of the BPLC display according to one exemplary embodiment of the invention have different ratios of electrode width to electrode slit and different cell gaps.

FIG. 7a is an operation voltage (Vop)-maximum transmittance (Tmax) comparison of blue sub-pixel areas of various exemplary embodiments of a display device of the invention, showing the relationship between the operation voltage (Vop)-maximum transmittance (Tmax) and the various cell gaps, electrode widths or electrode slits of the blue sub-pixel areas of the various display devices.

FIGS. 7b to 7d are operation voltage (Vop)-maximum transmittance (Tmax) comparisons of BPLC display devices according to various exemplary embodiments of the invention, showing the relationship between the operation voltage (Vop)-maximum transmittance (Tmax) and the various electrode widths or electrode slits of the various BPLC display devices while the cell gaps are respectively fixed as 3.9 μm, 3.4 μm and 2.9 μm.

FIG. 7e is cross sectional view of the BPLC display devices as shown in FIGS. 7b to 7d.

FIG. 8 is an operation voltage (Vop)-maximum transmittance (Tmax) comparison of BPLC display devices according to various exemplary embodiments of the invention, showing the relationship between the operation voltage (Vop)-maximum transmittance (Tmax) and the various cell gaps, electrode widths or electrode slits of sub-pixel areas, which allow lights of various main wavelengths transmitting therethrough, of the display devices.

FIG. 9 is a cross sectional view showing of a sub-pixel area of another exemplary embodiment of a BPLC display device of the invention.

FIG. 10 shows the relationship between the operation voltage (Vop)-maximum transmittance (Tmax) after varying the electrode width or electrode slit of red sub-pixel areas of the various BPLC display devices while the cell gap (d) is fixed as 5 μm and the electrode height (H) is fixed as 3 μm.

FIG. 11 is an operation voltage (Vop)-maximum transmittance (Tmax) comparison of BPLC display devices according to various exemplary embodiments of the invention while the cell gap (d) is fixed as 5 μm and the electrode height (H) is fixed as 3 μm.

FIGS. 12a to 12c are operation voltage (Vop)-maximum transmittance (Tmax) comparisons of BPLC display devices according to various exemplary embodiments of the invention in different electrode height (H) (1.5 μm, 3 μm and 4.5 μm) while the cell gap (d) are fixed as 5 μm.

FIGS. 13a to 13c are operation voltage (Vop)-maximum transmittance (Tmax) comparisons of BPLC display devices according to various exemplary embodiments of the invention in different electrode height (H) (1.5 μm, 3 μm and 4.5 μm) while the cell gap (d) are fixed as 8 μm.

FIGS. 14a and 14b are voltage-transmittance curve diagrams corresponding to the conventional BPLC display device and a BPLC display device according to one exemplary embodiment of the invention, wherein the various sub-pixel areas have different ratios of the electrode width to the electrode slit, at 45-degree and 90-degree viewing-angles.

FIG. 15 schematically shows an arrangement of an electronic device comprising one exemplary embodiment of a display device of the invention.

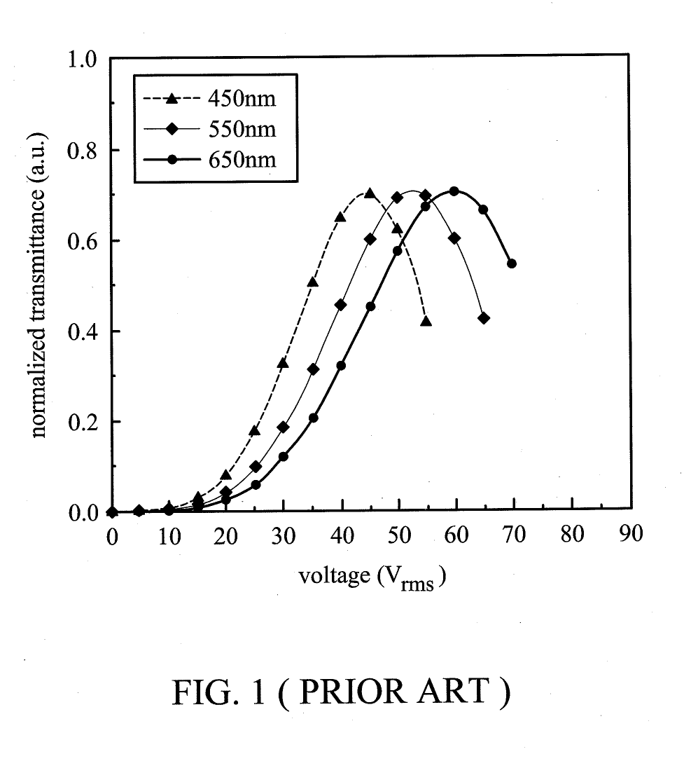

### DETAILED DESCRIPTION OF INVENTION

The following description is of a mode for carrying out the invention. This description is made for the purpose of illustrating the general principles of the invention and should not be taken in a limiting sense. The scope of the invention is best determined by reference to the appended claims. Wherever possible, the same reference numbers are used in the drawings and the descriptions to refer the same or like parts.

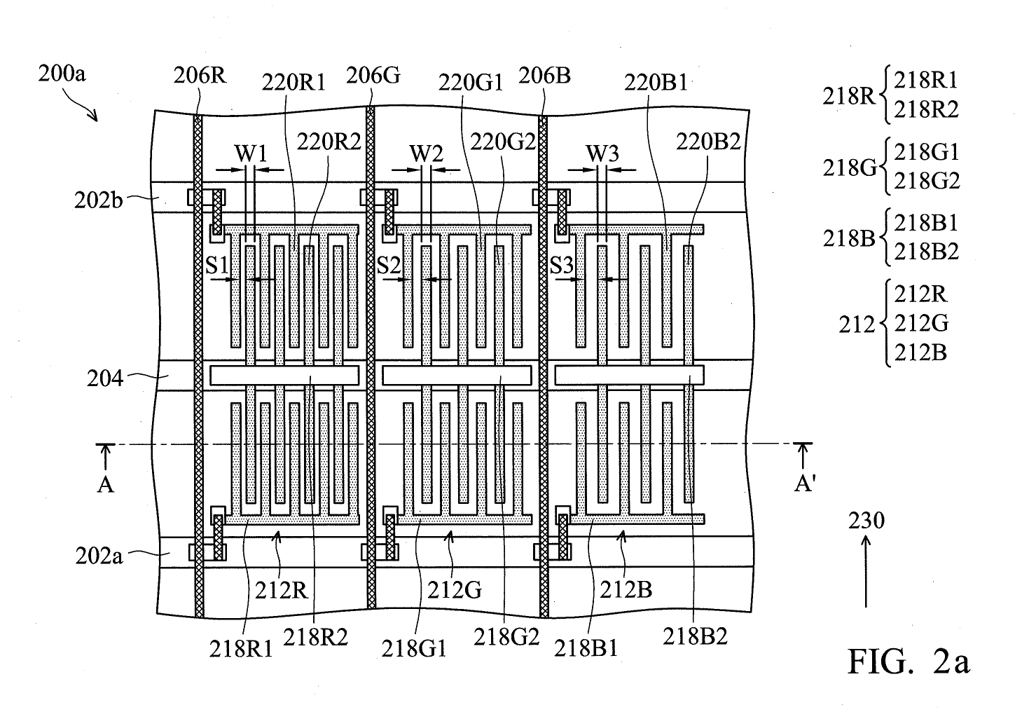

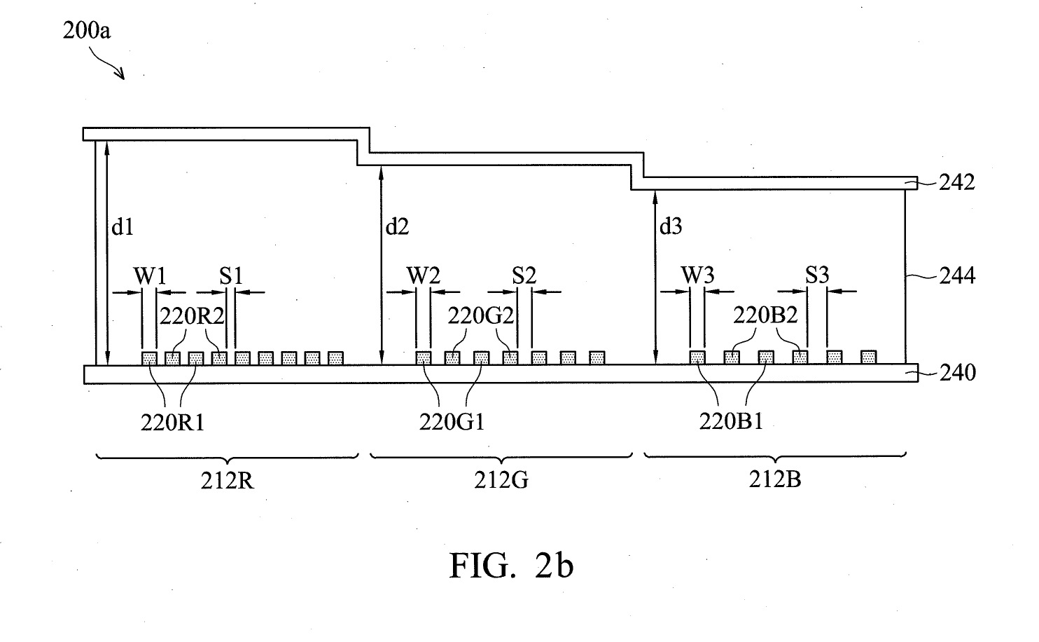

FIGS. 2a and 2b are respectively a top view and a cross sectional view taken along line A-A′ of FIG. 2a showing one exemplary embodiment of a pixel area 212 of a display device 200a of the invention. One exemplary embodiment of a display device 200a is a blue phase liquid crystal (BPLC) display device designed by the wide viewing-angle in-plane switching (IPS) technology. A second substrate (opposite substrate) and a blue phase liquid crystal (BPLC) layer are omitted in the top view of the pixel area 212 of the display device 200a (FIG. 2a) for brevity. As shown in FIGS. 2a and 2b, the display device 200a comprises a first transparent substrate 240 and a second transparent substrate 242. The transparent substrate 242 is disposed opposite to the first transparent substrate 240. In one embodiment, the first transparent substrate 240 may serve as a thin film transistor (TFT) substrate 240. A blue phase liquid crystal (BPLC) layer 244 is disposed between the first transparent substrate 240 and the second transparent substrate 242.

The pixel area 212 may be composed of three sub-pixel areas arranged side-by-side. The three sub-pixel areas are a first (red) sub-pixel area 212R, a second (green) sub-pixel area 212G and a third (blue) sub-pixel area 212B, respectively. The first (red) sub-pixel area 212R allows a light having a main wavelength of 650±30 nm transmitting therethrough, the second (green) sub-pixel area 212G allows a light having a main wavelength of 550±30 nm transmitting therethrough, and the third (blue) sub-pixel area 212B allows a light having a main wavelength of 450±30 nm transmitting therethrough.

The first (red) sub-pixel area 212R is defined by gate lines 202a and 202b, and a data line 206R. The gate lines 202a and 202b are disposed on a surface 214 of the first transparent substrate 240, which is opposite to the second transparent substrate 242. The data line 206R along a direction 230 is vertical to the gate lines 202a and 202b. The second (green) sub-pixel area 212G is defined by the gate lines 202a and 202b, and a data line 206G. The data line 206G along a direction 230 is vertical to the gate lines 202a and 202b. The third (blue) sub-pixel area 212B is defined by the gate lines 202a and 202b and a data line 206B. The data line 206B along a direction 230 is vertical to the gate lines 202a and 202b. Additionally, a common electrode line 204 is also disposed on the surface 214 of the first transparent substrate 240. The common electrode line 204 passes through the first (red) sub-pixel area 212R, the second (green) sub-pixel area 212G and the third (blue) sub-pixel area 212B.

As shown in FIG. 2a, each of the sub-pixel areas has an interdigitated electrode disposed therein. For example, the first (red) sub-pixel area 212R has a first interdigitated electrode 218R disposed on the surface 214 of the first transparent substrate 240. The first interdigitated electrode 218R comprises two comb-like electrode portions 218R1 and 218R2. The comb-like electrode portion 218R1 has a plurality of electrode strips 220R1 parallel to each other, extending along the direction 230. Also, the comb-like electrode portion 218R2 has a plurality of electrode strips 220R2 parallel to each other, extending along the direction 230. The electrode strips 220R1 and the electrode strips 220R2 have a first electrode width W1. Further, the electrode strip 220R1 is disposed close to the electrode strip 220R2, separated from each other by a first electrode slit S1.

Similarly, the second (green) sub-pixel area 212G has a second interdigitated electrode 218G disposed on the surface 214 of the first transparent substrate 240. The second interdigitated electrode 218G comprises two comb-like electrode portions 218G1 and 218G2. The comb-like electrode portions 218G1 and 218G2 respectively have a plurality of parallel electrode strips 220G1 and 220G2. The electrode strips 220G1 and the electrode strips 220G2 have a second electrode width W2. Further, the electrode strip 220G1 is disposed close to the electrode strip 220G2, separated from each other by a second electrode slit S2. Additionally, the third (blue) sub-pixel area 212B has a third interdigitated electrode 218B disposed on the surface 214 of the first transparent substrate 240. The third interdigitated electrode 218B comprises two comb-like electrode portions 218B1 and 218B2. The comb-like electrode portions 218B1 and 218B2 respectively have a plurality of parallel electrode strips 220B1 and 220B2. The electrode strips 220B1 and the electrode strips 220B2 have a third electrode width W3. Further, the electrode strip 22B1 is disposed close to the electrode strip 220B2, separated from each other by a third electrode slit S3. As shown in FIG. 2a, the electrode strips 220R1 and the electrode strips 220R2 in the first (red) sub-pixel area 212R are parallel to the data line 206R. The electrode strips 220G1 and the electrode strips 220G2 in the second (green) sub-pixel area 212G are parallel to the data line 206G. Also, the electrode strips 220B1 and the electrode strips 220B2 in the third (blue) sub-pixel area 212B are parallel to the data line 206B. As shown in FIG. 2b, the BPLC layer 244 covers the first (red) sub-pixel area 212R, the second (green) sub-pixel area 212G and the third (blue) sub-pixel area 212B. Cell gaps (the cell gap is defined by a distance between the first transparent substrate 240 and the second transparent substrate 242) of the first (red) sub-pixel area 212R, the second (green) sub-pixel area 212G and the third (blue) sub-pixel area 212B are labeled as d1, d2 and d3, respectively.

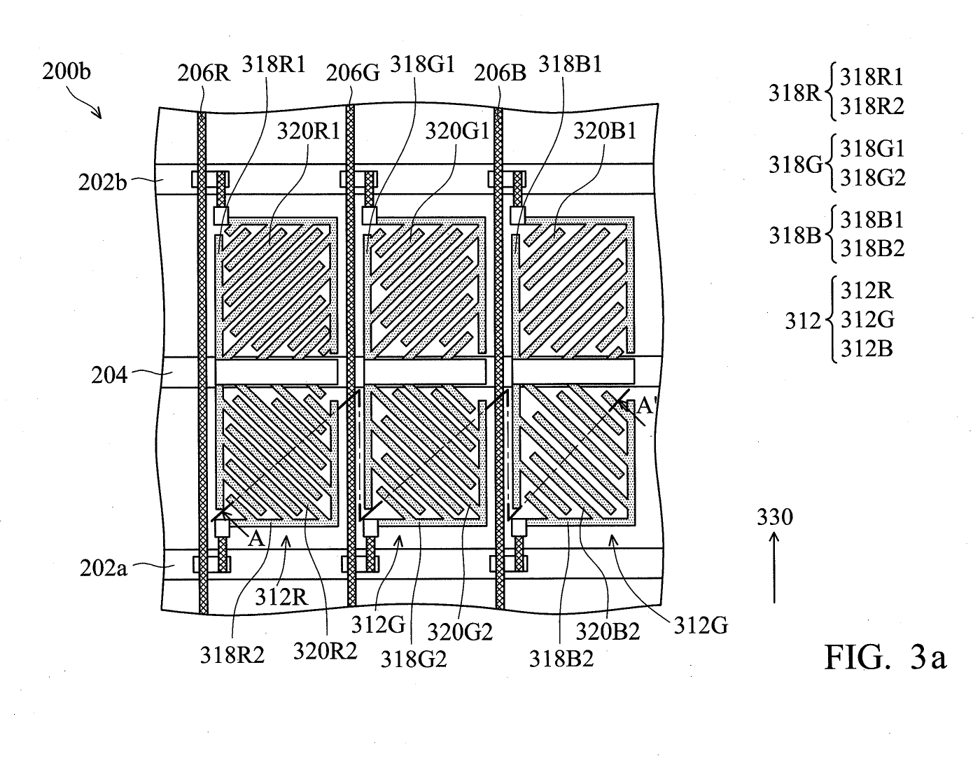

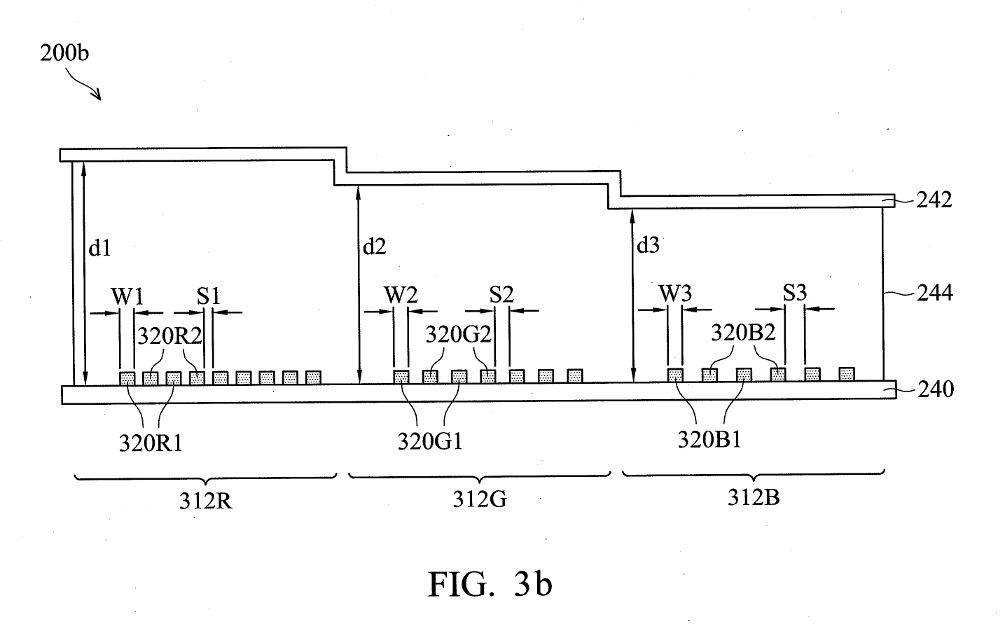

FIGS. 3a and 3b are respectively a top view and a cross sectional view taken along line A-A′ of FIG. 3a showing another exemplary embodiment of a pixel area 312 of a display device 200b of the invention. Differences between the display device 200a and the display device 200b are that an angle between electrode strips 320R1, 320R2 of comb-like electrodes 318R1, 318R2 of a first interdigitated electrode 318R of a first (red) sub-pixel area 312R and a data line 206R is 45 degrees. An angle between electrode strips 320G1, 320G2 of comb-like electrodes 318G1, 318G2 of a second interdigitated electrode 318G of a second (green) sub-pixel area 312G and a data line 206G is 45 degrees. An angle between electrode strips 320B1, 320B2 of comb-like electrodes 318B1, 318B2 of a third interdigitated electrode 318B of a third (blue) sub-pixel area 312G and a data line 206B is also 45 degrees.

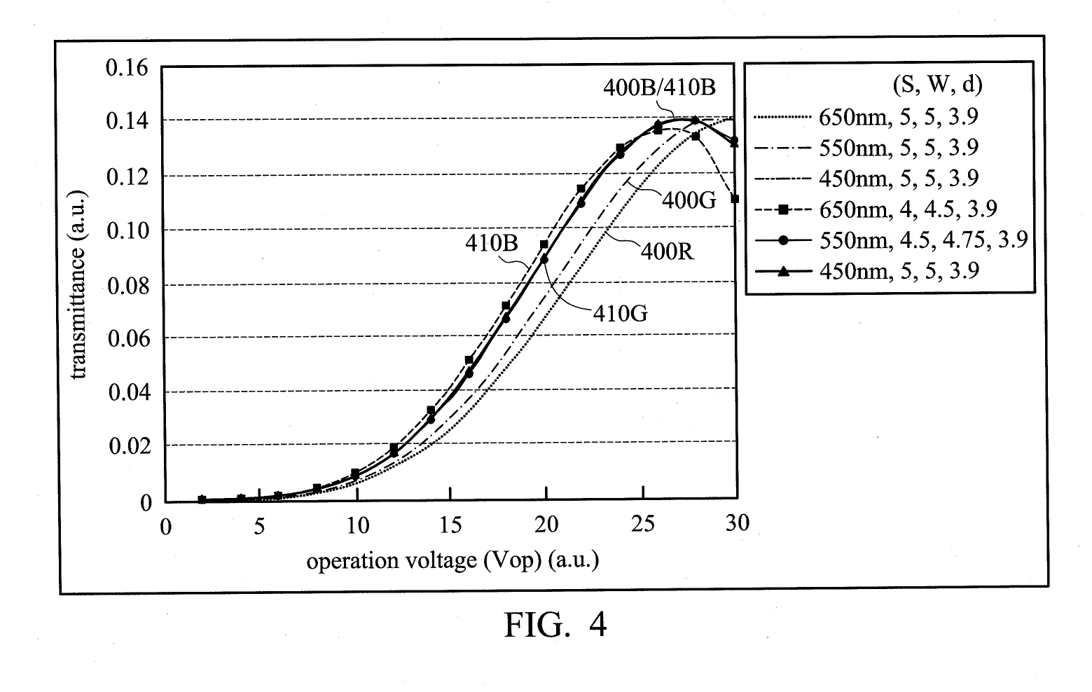

Embodiments of a display device of the invention may change intensity and direction distributions of electric fields produced in the different sub-pixel areas by tuning the cell gaps of the different sub-pixel areas, electrode widths (W) or electrode slits (S) of the interdigitated electrodes of the different sub-pixel areas. A voltage-transmittance curve of the sub-pixel area allowing a light of a low main wavelength transmitting therethrough may shift toward a direction of a higher voltage. Therefore, the voltage-transmittance curves of the different sub-pixel areas can fully overlap with each other. The dispersion of the different sub-pixel areas can be reduced. FIGS. 4-6 are operation voltage-transmittance curve comparison diagrams between the conventional BPLC display device and a BPLC display device according to various exemplary embodiments of the invention. Parameters of the Kerr model used in the first (red) sub-pixel area 212R, the second (green) sub-pixel area 212G and the third (blue) sub-pixel area 212B of a BPLC display device according to various exemplary embodiments of the invention are shown in Table 1, wherein K is Kerr constant and Es is the saturation electric field.

TABLE 1

| | | |
|---|---|---|
| main wavelength (nm) of a light for | | |
| transmitting the sub-pixel area | K(nm/V\hat{ }2) | Es(V/μm) |

| | | |
|---|---|---|
| 450 ± 30 (red) | 20 | 13.9 |
| 550 ± 30 (green) | 14.3 | 13.9 |
| 650 ± 30 (blue) | 11.2 | 13.9 |

FIG. 4 is an operation voltage-transmittance curve comparison diagram of the conventional BPLC display device and a BPLC display device according to one exemplary embodiment of the invention, showing that the different sub-pixel areas of the BPLC display device according to one exemplary embodiment of the invention have different ratios of electrode width to electrode slit. The operation voltage-transmittance curve comparison diagram as shown in FIG. 4 uses the display device 200a as shown in FIGS. 2a and 2b to simulate and calculate the relationship between the transmittance and the operation voltage of the BPLC display device. As shown in FIG. 4, red, green and blue sub-pixel areas of the conventional BPLC display device have a fixed electrode slit (S=5 μm), electrode width (W=5 μm) and cell gap (d=3.9 μm). Therefore, the transmittance of the sub-pixel area having a short wavelength may shift toward a direction of a lower voltage. More specifically, the operation voltage-transmittance curves of the red sub-pixel area (400R), green sub-pixel (400G) area and blue sub-pixel area (400B) of the conventional BPLC display device may gradually shift toward a direction of a lower voltage. A ratio of the electrode width to the electrode slit of the first (red) sub-pixel area, the second (green) sub-pixel area and the third (blue) sub-pixel area of a BPLC display device according to one exemplary embodiment of the invention is designed to satisfy Equation (1) and Equation (2)

$$\begin{matrix}( \frac{W 1}{S 1} ) \approx ( \frac{W 2}{S 2} ) \approx ( \frac{W 3}{S 3} ) & Equation ( 1 ) \\ ( S 1 ) < ( S 2 ) < ( S 3 ) & Equation ( 2 )\end{matrix}$$

wherein W1, W2 and W3 are respectively electrode widths of the first (red) sub-pixel area, the second (green) sub-pixel area and the third (blue) sub-pixel area, and S1, S2 and S3 are respectively electrode slits of the first (red) sub-pixel area, the second (green) sub-pixel area and the third (blue) sub-pixel area of a BPLC display device according to one exemplary embodiment of the invention.

In the embodiment as shown in FIG. 4, according to the design satisfying Equation (1) and Equation (2), the electrode slit (S), electrode width (W) and cell gap (d) of a red sub-pixel area (410R) of a BPLC display device according to one exemplary embodiment are 4 μm, 4.5 μm and 3.9 μm, respectively. The electrode width (W), electrode slit (S) and cell gap (d) of a green sub-pixel area (410G) of a BPLC display device according to one exemplary embodiment are 4.5 μm, 4.75 μm and 3.9 μm, respectively. Also, the electrode width (W), electrode slit (S) and cell gap (d) of a blue sub-pixel area (410B) of a BPLC display device according to one exemplary embodiment are 5 μm, 5 μm and 3.9 μm, respectively. Also, as shown in FIG. 4, the operation voltage-transmittance curves of the red sub-pixel area (410R), green sub-pixel area (410G) and blue sub-pixel area (410B) of a BPLC display device according to one exemplary embodiment may substantially fully overlap with each other. That is to say, the red sub-pixel area (410R), green sub-pixel area (410G) and blue sub-pixel area (410B) of a BPLC display device according to one exemplary embodiment may have substantially the same operation voltage (Vop) (e.g. the operation voltage corresponding to the maximum transmittance).

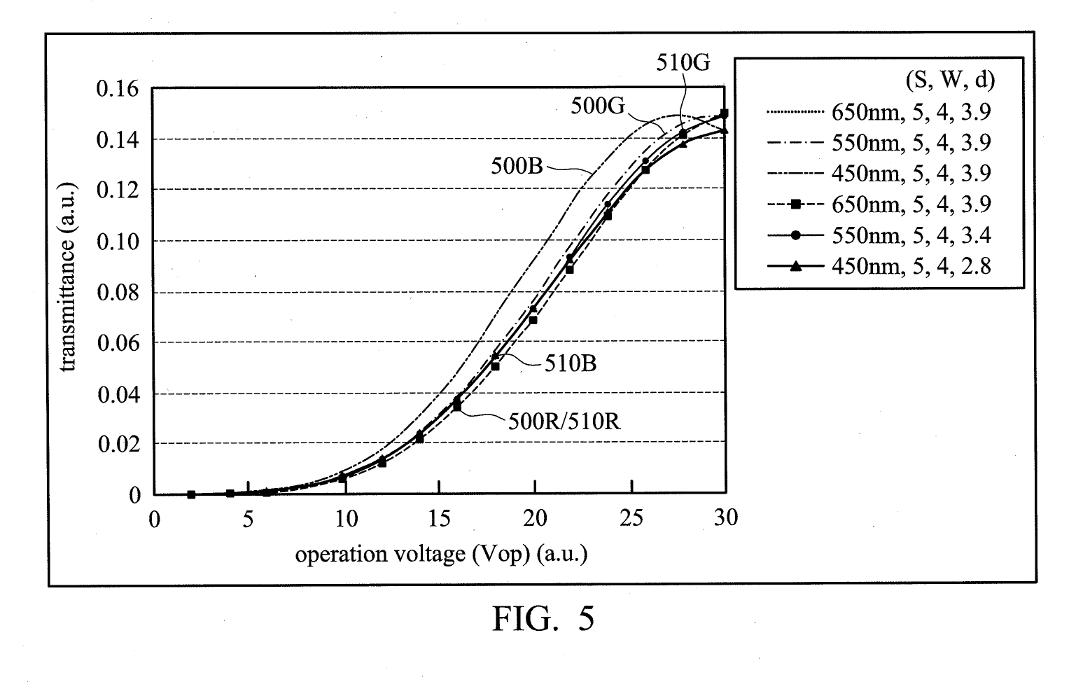

FIG. 5 is an operation voltage-transmittance curve comparison diagram of the conventional BPLC display device and a BPLC display device according to another exemplary embodiment of the invention, showing that the different sub-pixel areas of the BPLC display according to one exemplary embodiment of the invention have different cell gaps. The operation voltage-transmittance curve comparison diagram as shown in FIG. 5 uses the display device 200a as shown in FIGS. 2a and 2b to simulate and calculate the relationship between the transmittance and the operation voltage of the BPLC display device. As shown in FIG. 5, red, green and blue sub-pixel areas of the conventional BPLC display device have a fixed electrode slit (S=5 μm), electrode width (W=4 μm) and cell gap (d=3.9 μm). Therefore, the transmittance of the sub-pixel area having a short wavelength may shift toward a direction of a lower voltage. More specifically, the operation voltage-transmittance curves of the red sub-pixel area (500R), green sub-pixel (500G) area and blue sub-pixel area (500B) of the conventional BPLC display device may gradually shift toward a direction of a lower voltage. A ratio of the electrode width to the electrode slit of the first (red) sub-pixel area, the second (green) sub-pixel area and the third (blue) sub-pixel area of a BPLC display device according to another exemplary embodiment of the invention is designed to satisfy Equation (1) and Equation (3)

(d1)>(d2)>(d3) Equation (3)

, wherein d1, d2 and d3 are respectively cell gaps of the first (red) sub-pixel area, the second (green) sub-pixel area and the third (blue) sub-pixel area of a BPLC display device according to one exemplary embodiment of the invention.

In the embodiment as shown in FIG. 5, according to the design satisfying Equation (1) and Equation (3), the electrode width (W), electrode slit (S) and cell gap (d) of a red sub-pixel area (510R) of a BPLC display device according to one exemplary embodiment are 5 μm, 4 μm and 3.9 μm, respectively. The electrode width (W), electrode slit (S) and cell gap (d) of a green sub-pixel area (510G) of a BPLC display device according to one exemplary embodiment are 5 μm, 4 μm and 3.4 μm, respectively. Also, the electrode width (W), electrode slit (S) and cell gap (d) of a blue sub-pixel area (510B) of a BPLC display device according to one exemplary embodiment are 5 μm, 4 μm and 2.8 μm, respectively. Also, as shown in FIG. 5, the operation voltage-transmittance curves of the red sub-pixel area (510R), green sub-pixel area (510G) and blue sub-pixel area (510B) of a BPLC display device according to another exemplary embodiment may substantially fully overlap with each other. That is to say, the red sub-pixel area (510R), green sub-pixel area (510G) and blue sub-pixel area (510B) of a BPLC display device according to another exemplary embodiment may have operation voltage (Vop) (e.g. the operation voltage corresponding to the maximum transmittance) substantially the same as each other. From FIG. 5, it is shown that when the various sub-pixel areas have the electrode widths, which are the same as the electrode slits, and the cell gap decreases by increasing the main wavelength of a light allowed transmitting through the various sub-pixel areas, the Vop has an increasing trend. Also, the maximum transmittance (Tmax) has a decreasing trend. However, the variation of Vop affected by the various cell gaps is more than the variation of Tmax. Therefore, Vop can be fine-tuned by adjusting the cell gap of the sub-pixel area. Also, Tmax is slightly affected by adjusting the cell gap of the sub-pixel area.

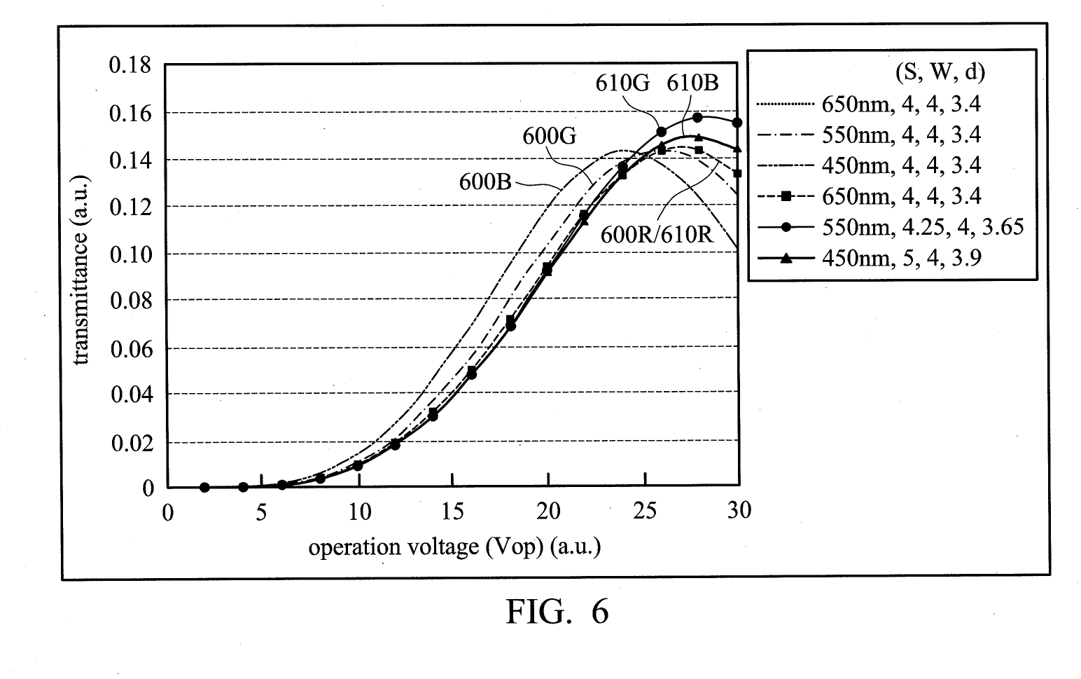

FIG. 6 is an operation voltage-transmittance curve comparison diagram of the conventional BPLC display device and a BPLC display device according to yet another exemplary embodiment of the invention. The different sub-pixel areas of the BPLC display according to one exemplary embodiment of the invention have different ratios of electrode width to electrode slit and different cell gaps. The operation voltage-transmittance curve comparison diagram as shown in FIG. 6 uses the display device 200a as shown in FIGS. 2a and 2b to simulate and calculate the relationship between the transmittance and the operation voltage of the BPLC display device. As shown in FIG. 6, red, green and blue sub-pixel areas of the conventional BPLC display device have a fixed electrode slit (S=4 μm), electrode width (W=4 μm) and cell gap (d=3.4 μm). Therefore, the transmittance of the sub-pixel area having a short wavelength may shift toward a direction of a lower voltage. More specifically, the operation voltage-transmittance curves of the red sub-pixel area (600R), green sub-pixel (600G) area and blue sub-pixel area (600B) of the conventional BPLC display device may gradually shift toward a direction of a lower voltage. The ratio of the electrode width to the electrode slit and the cell gap (d) of the first (red) sub-pixel area, the second (green) sub-pixel area and the third (blue) sub-pixel area of a BPLC display device according to another exemplary embodiment of the invention are designed to satisfy Equations (1)-(3). Therefore, according to the design satisfying. Equations (1)-(3), the electrode width (W), electrode slit (S) and cell gap (d) of a red sub-pixel area (610R) of a BPLC display device according to one exemplary embodiment are 4 μm, 4 μm and 3.4 μm, respectively. The electrode width (W), electrode slit (S) and cell gap (d) of a green sub-pixel area (610G) of a BPLC display device according to one exemplary embodiment are 4.25 μm, 4 μm and 3.65 μm, respectively. Also, the electrode width (W), electrode slit (S) and cell gap (d) of a blue sub-pixel area (610B) of a BPLC display device according to one exemplary embodiment are 5 μm, 4 μm and 3.9 μm, respectively. Also, as shown in FIG. 6, the operation voltage-transmittance curves of the red sub-pixel area (610R), green sub-pixel area (610G) and blue sub-pixel area (610B) of a BPLC display device according to another exemplary embodiment may substantially, fully overlap with each other. That is to say, the red sub-pixel area (610R), green sub-pixel area (610G) and blue sub-pixel area (610B) of a BPLC display device according to another exemplary embodiment may have substantially the same operation voltage (Vop) (e.g. the operation voltage corresponding to the maximum transmittance).

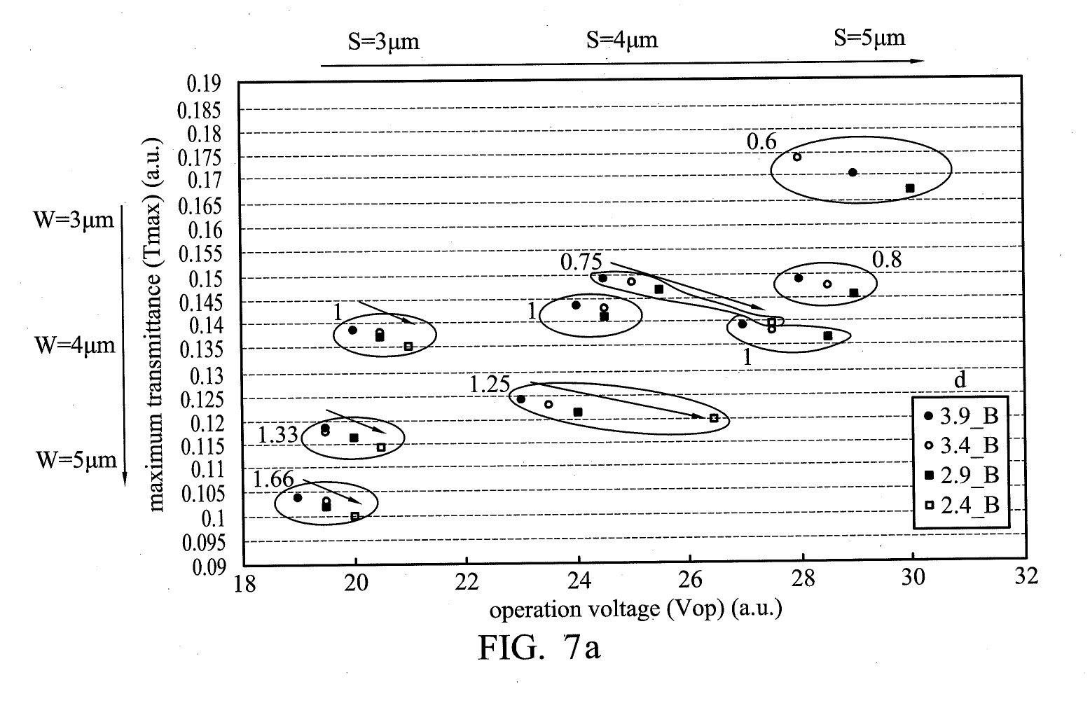

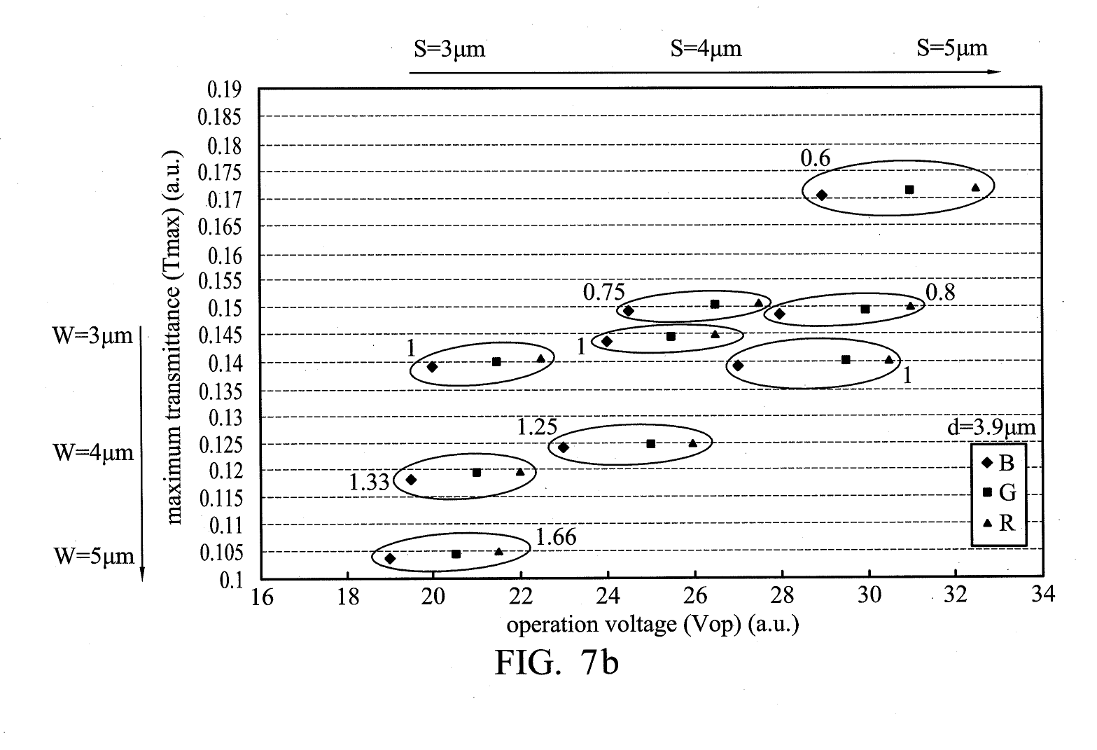

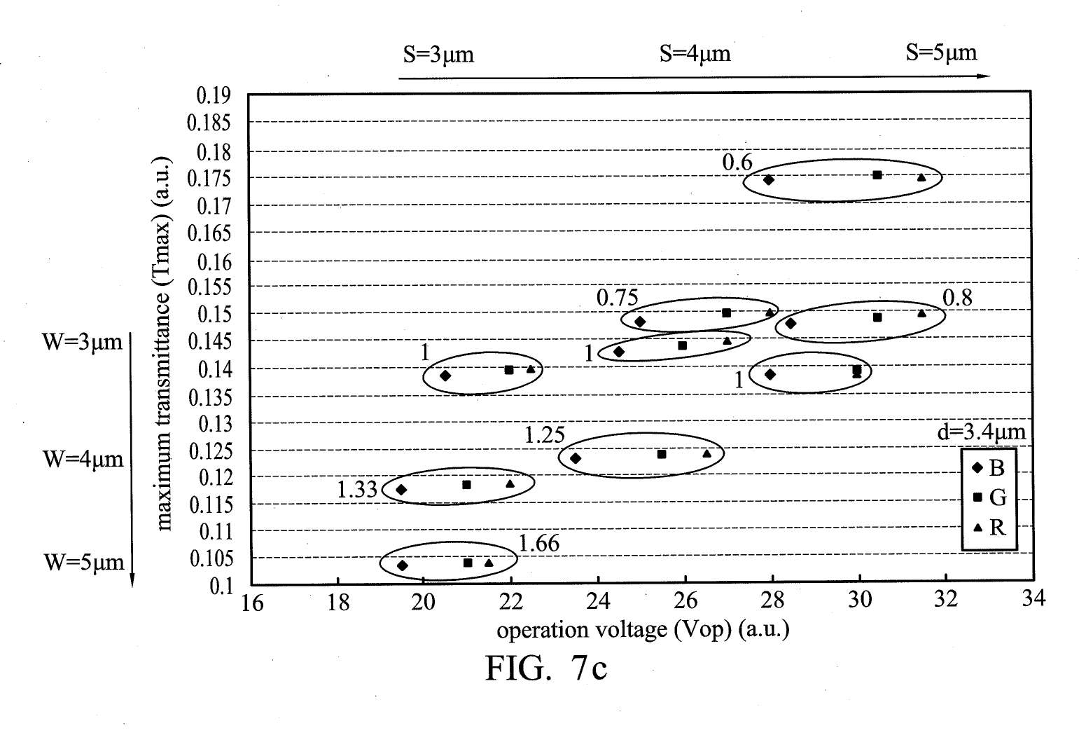

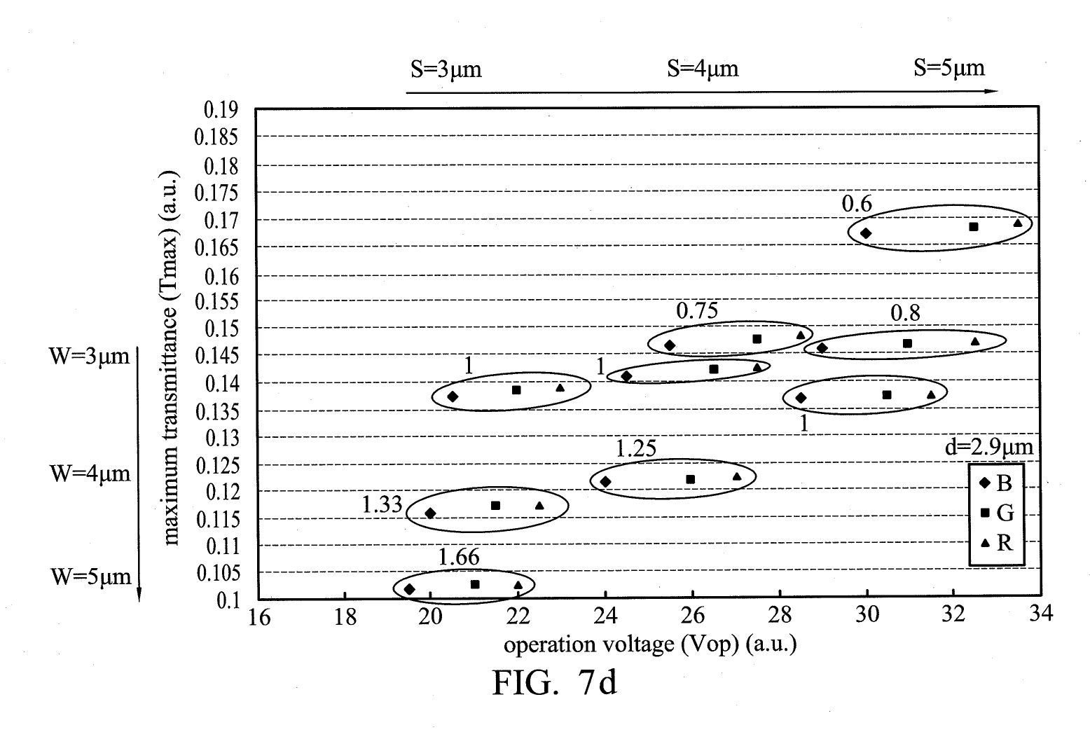

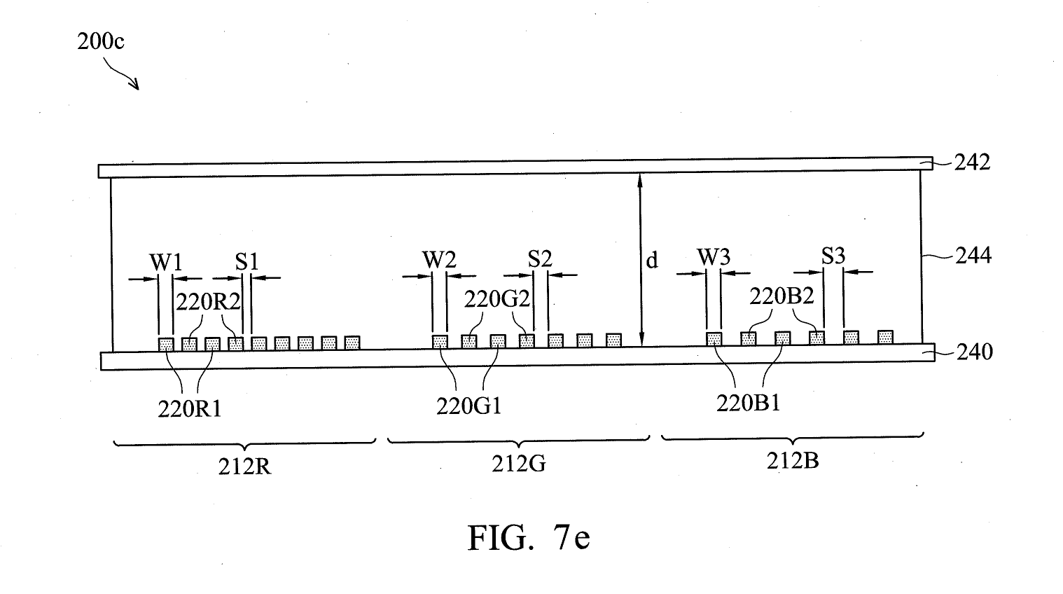

FIG. 7a is an operation voltage (Vop)-maximum transmittance (Tmax) comparison of blue sub-pixel areas of various exemplary embodiments of a display device of the invention, showing the relationship between the operation voltage (Vop)-maximum transmittance (Tmax) and the various cell gaps, electrode widths or electrode slits of the blue sub-pixel areas of the various display devices. In FIG. 7a, data points of the blue sub-pixel areas of the various display devices with the same ratio of the electrode width to the electrode slit and the different cell gaps (d) may be surrounded by a single circle (a data point with d=3.9 is labeled as a solid circular point, a data point with d=3.4 is labeled as a hollow circular point, and a data point with d=2.4 is labeled as a hollow square point). And the ratio of the electrode width to the electrode slit (S) may be noted close to the circle. Additionally, varied values of the electrode width (W) may be 3 μm, 4 μm and 5 μm. Also, varied values of the electrode slit (S) may be 3 μm, 4 μm and 5 μm. From FIG. 7a, when the cell gap of the blue sub-pixel area is reduced, the corresponding operation voltage (Vop) has an increasing trend, but the maximum transmittance (Tmax) substantially has a decreasing trend. When the electrode slit (S) keeps the same value by increasing the electrode width (W), the corresponding operation voltage (Vop) and the maximum transmittance (Tmax) both have a decreasing trend. Also, the variation of Tmax affected by increasing the electrode widths (W) is more than the variation of Vop. Therefore, Tmax can be fine-tuned by adjusting the electrode width (W) of the sub-pixel area. Also, Vop is slightly affected by adjusting the electrode width (W) of the sub-pixel area. Additionally, when the electrode width (W) keeps the same value after decreasing the electrode slit (S), the corresponding operation voltage (Vop) and the maximum transmittance (Tmax) both have a decreasing trend. Also, the variation of Vop affected by decreasing the electrode slit (S) is more than the variation of Tmax. Therefore, Vop can be fine-tuned by adjusting the electrode slit (S) of the sub-pixel area. Also, Tmax is slightly affected by adjusting the electrode slit (S) of the sub-pixel area.

FIGS. 7b to 7d are operation voltage (Vop)-maximum transmittance (Tmax) comparisons of BPLC display devices according to various exemplary embodiments of the invention. FIG. 7e is cross sectional view of a sub-pixel area 212 of the BPLC display device 200c as shown in FIGS. 7b to 7d. FIGS. 7b to 7d show the relationship between the operation voltage (Vop)-maximum transmittance (Tmax) after varying the electrode width or electrode slit of the various BPLC display devices while the cell gaps are respectively fixed as 3.9 μm, 3.4 μm and 2.9 μm. In FIGS. 7b to 7d, data points of the blue sub-pixel areas (diamond-shaped point), green sub-pixel areas (square point) and red sub-pixel areas (triangular-shaped point) of the various display devices with the same ratio of the electrode width to the electrode slit (S) may be surrounded by a single circle. And the ratio of the electrode width to the electrode slit (S) may be noted close to the circle. Additionally, varied values of the electrode width (W) may be 3 μm, 4 μm and 5 μm. Also, varied values of the electrode slit (S) may be 3 μm, 4 μm and 5 μm. The trend of the operation voltage (Vop)-maximum transmittance (Tmax) as shown in FIGS. 7b to 7d is substantially similar to the trend of the operation voltage (Vop)-maximum transmittance (Tmax) as shown in FIG. 7a. From FIGS. 7b to 7d, it is shown that when the cell gap of the sub-pixel area is reduced, the corresponding operation voltage (Vop) has an increasing trend. Therefore, the sub-pixel area allowing a light of a shorter main wavelength transmitting therethrough is required to be designed to have a smaller corresponding cell gap (d).

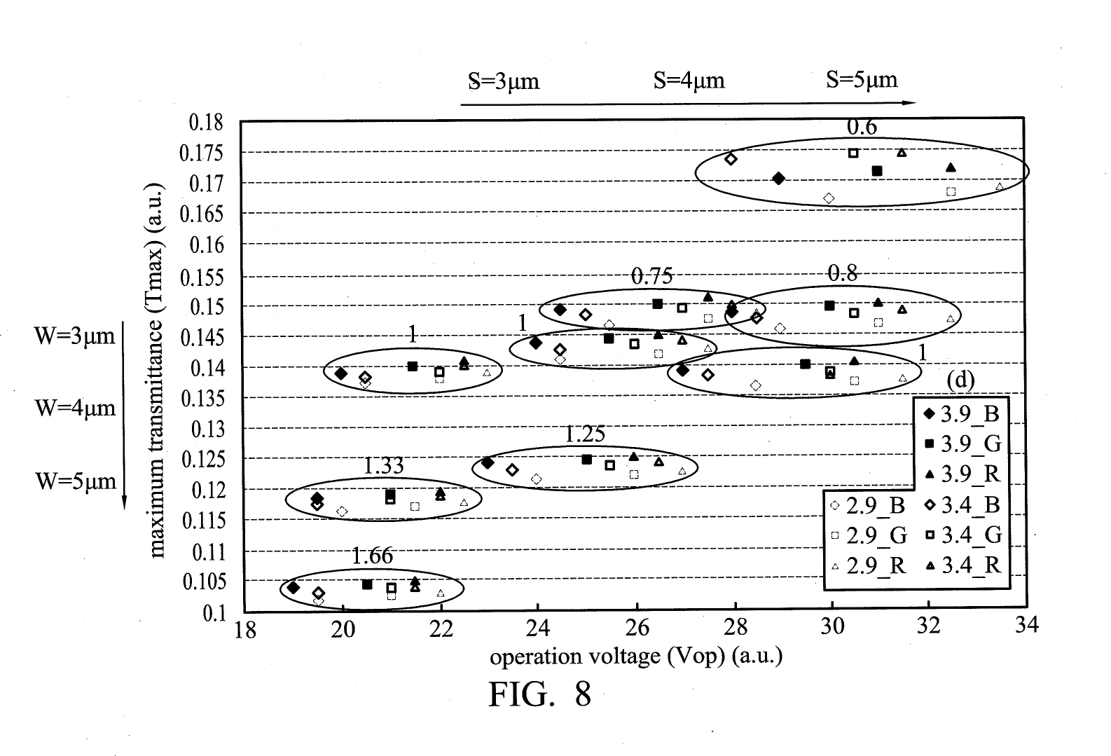

FIG. 8 is an operation voltage (Vop)-maximum transmittance (Tmax) comparison of BPLC display devices according to various exemplary embodiments of the invention, showing the relationship between the operation voltage (Vop)-maximum transmittance (Tmax) and the various cell gaps, electrode widths or electrode slits of sub-pixel areas, which allow light of various main wavelengths transmitting therethrough, of the display devices. FIG. 8 is also a figure showing the combination of FIGS. 7b to 7d. In FIG. 8, data points of the blue sub-pixel areas (diamond-shaped point), green sub-pixel areas (square point) and red sub-pixel areas (triangular-shaped point) of the various display devices with the same ratio of the electrode width to the electrode slit (S) may be surrounded by a single circle. And the ratio of the electrode width to the electrode slit (S) may be noted close to the circle. Also, data points of the blue sub-pixel areas (diamond-shaped point), green sub-pixel areas (square point) or red sub-pixel areas (triangular-shaped point) of the various display devices with different cell gaps (d) may be respectively plotted with the same shape and different frames (a data point with d=3.9 is plotted as a solid-shaped point, a data point with d=3.4 is plotted as a hollow-shaped point, and a data point with d=2.9 is plotted as a point plotted by a dotted line). Additionally, varied values of the electrode width (W) may be 3 μm, 4 μm and 5 μm. Also, varied values of the electrode slit (S) may be 3 μm, 4 μm and 5 μm. Further, varied values of the cell gap (d) may be 3.9 μm, 3.4 μm and 2.9 μm.

From the results of FIGS. 4-6, 7a-7d and 8, it is shown that when the ratio of the electrode width to the electrode slit of the different sub-pixel areas of the BPLC display device are substantially the same as each other, the corresponding maximum transmittance (Tmax) are substantially the same as each other. Additionally, when the cell gap decreases by increasing the main wavelength of a light allowed transmitting through the various sub-pixel areas, the Vop has an increasing trend. Therefore, in one embodiment, the electrode of the sub-pixel area of the BPLC display device may be designed to satisfy Equation (1) and Equation (2). In another embodiment, the electrode of the sub-pixel area of the BPLC display device may be designed to satisfy Equations (1), (2) and (3). Alternatively, the electrode of the sub-pixel area of the BPLC display device may be designed to satisfy Equations (1), (2) and (4), Equations (1), (3) and (4), or Equations (1)-(4).

$$Δ ( \frac{W}{S} ) < 0.2 , wherein Δ ( \frac{W}{S} ) \qquad Equation ( 4 )$$

is the difference of ratios of the electrode width to the electrode slit of any two sub-pixel areas of the BPLC display device according to one exemplary embodiment of the invention. Therefore, Equation (4) means that the difference of ratios of the electrode width to the electrode slit of any two sub-pixel areas of the BPLC display device is less than 0.2. That is to say, the data points of the blue sub-pixel area (diamond-shaped point), green sub-pixel area (square point) and red sub-pixel area (triangular-shaped point) of the same display device as shown in FIGS. 7a-7d and 8 are designed as close as possible.

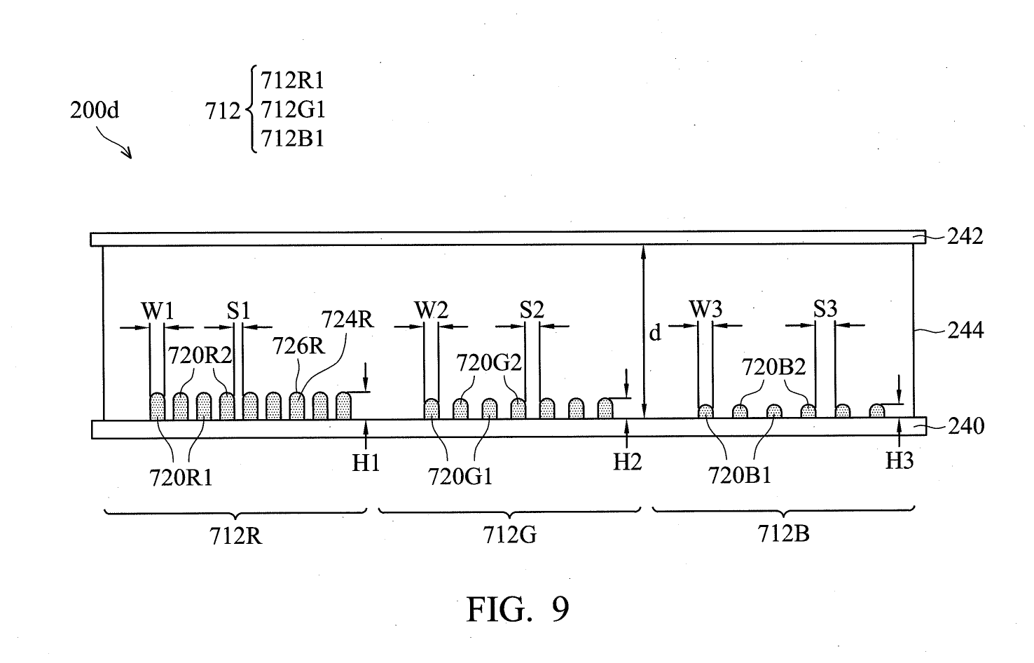

Alternatively, interdigitated electrodes of a blue phase liquid crystal (BPLC) display device designed by the wide viewing-angle in-plane switching (IPS) technology may be designed protruding into a portion of the blue phase liquid crystal (BPLC) layer. FIG. 9 is a cross sectional view showing of a sub-pixel area 712 of another exemplary embodiment of a BPLC display device 200d of the invention. Also, a top view of the sub-pixel area 712 may be similar to the sub-pixel area 212 as shown in FIG. 2a and the sub-pixel area 312 as shown in FIG. 3a.

As shown in FIG. 9, electrode strips 720R1 and 720R2 of comb-like electrode portions of a first interdigitated electrode of a first (red) sub-pixel area 712R are alternatively arranged and parallel to each other. The electrode strips 720R1 and the electrode strips 720R2 have a first electrode width W1. Further, the electrode strip 720R1 is disposed close to the electrode strip 720R2, separated from each other by a first electrode slit S1. In one embodiment, each of the electrode strips 720R1 and 720R2 may be constructed by a protrusion 724R and a conductive electrode 726R covering the protrusion 724R as shown in FIG. 9. Alternatively, each of the electrode strips 720R1 and 720R2 may be constructed by the protrusion 724R formed by conductive materials, thereby without requiring the conductive electrode 726R. In one embodiment, a cross section of each of the electrode strips 720R1 and 720R2 may have a semi-circular shape, semi-elliptical shape, or ladder shape.

Moreover, the electrode strips 720R1 and 720R2 have a first electrode height H1. Similarly, electrode strips 720G1 and 720G2 of comb-like electrode portions of a second interdigitated electrode of a second (green) sub-pixel area 712G have a second electrode width W2. Further, the electrode strip 720G1 is disposed close to the electrode strip 720G2, separated from each other by a second electrode slit S2. Moreover, the electrode strips 720G1 and 720G2 have a second electrode height H2. Additionally, electrode strips 720B1 and 720B2 of comb-like electrode portions of a third interdigitated electrode of a third (blue) sub-pixel area 712B have a third electrode width W3. Further, the electrode strip 720B1 is disposed close to the electrode strip 720B2, separated from each other by a third electrode slit S3. Moreover, the electrode strips 720B1 and 720B2 have a third electrode height H3. In this embodiment, cell gaps (the cell gap is defined by a distance between the first transparent substrate 240 and the second transparent substrate 242) of the first (red) sub-pixel area 712R, the second (green) sub-pixel area 712G and the third (blue) sub-pixel area 712B are labeled as d.

Embodiments of a display device of the invention may change intensity and direction distributions of electric fields produced in the different sub-pixel areas by further tuning the electrode heights (H) of the interdigitated electrodes of the different sub-pixel areas. A voltage-transmittance curve of the sub-pixel area allowing a light of a low main wavelength transmitting therethrough may shift toward a direction of a higher voltage. Therefore, the voltage-transmittance curves of the different sub-pixel areas can fully overlap with each other. The dispersion of the different sub-pixel areas can be reduced. Parameters of the Kerr model used in the first (red) sub-pixel area 712R, the second (green) sub-pixel area 712G and the third (blue) sub-pixel area 712B of a BPLC display device 200c according to another exemplary embodiment of the invention are shown in Table 2, wherein dnₛₐₜ is the saturated induced birefringence, K is Kerr constant and Es is the saturation electric field.

TABLE 2

| main wavelength (nm) of a light for | | | |
|---|---|---|---|
| transmitting the sub-pixel area | dnₛₐₜ | K(nm/V\hat{ }2) | Es(V/μm) |
| 450 ± 30 (red) | 0.109 | 5.24 | 6.8 |
| 550 ± 30 (green) | 0.099 | 3.89 | 6.8 |
| 650 ± 30 (blue) | 0.094 | 3.08 | 6.8 |

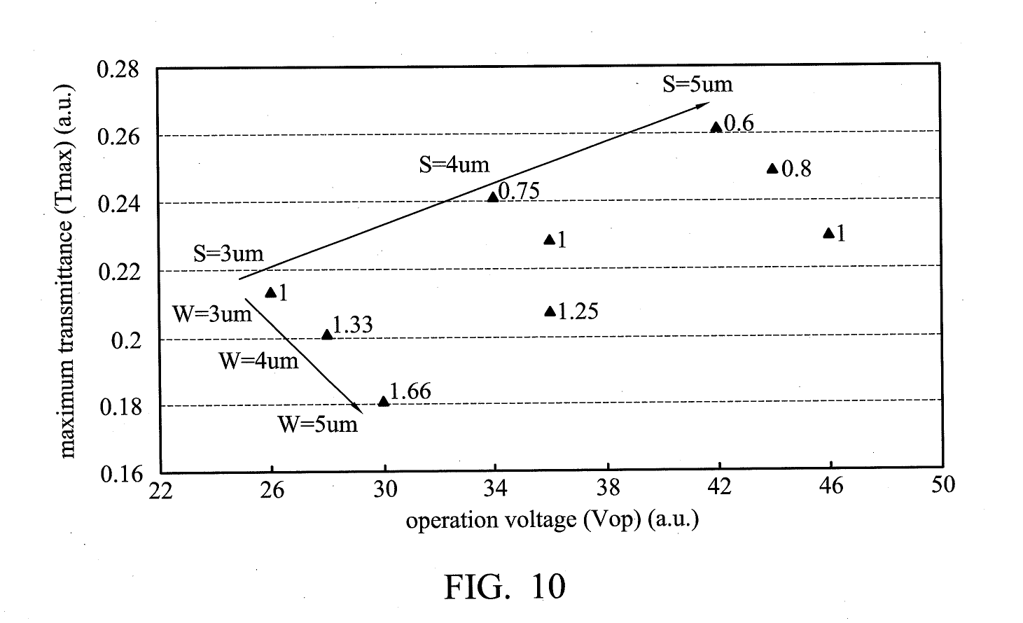

FIG. 10 shows the relationship between the operation voltage (Vop)-maximum transmittance (Tmax) after varying the electrode width or electrode slit of red sub-pixel areas of the various BPLC display devices while the cell gap (d) is fixed as 5 μm and the electrode height (H) is fixed as 3 μm. In FIG. 10, the ratio of the electrode width to the electrode slit (S) may be noted close to the data points. Additionally, varied values of the electrode width (W) may be 3 μm, 4 μm and 5 μm. Also, varied values of the electrode slit (S) may be 3 μm, 4 μm and 5 μm. From the trend of the operation voltage (Vop)-maximum transmittance (Tmax) as shown in FIG. 10, it is shown that when the ratio of the electrode width to the electrode slit of various BPLC display devices keeps the same value after decreasing the electrode slit (S), the corresponding operation voltage (Vop) has a decreasing trend, but the change of the corresponding maximum transmittance (Tmax) is not obvious.

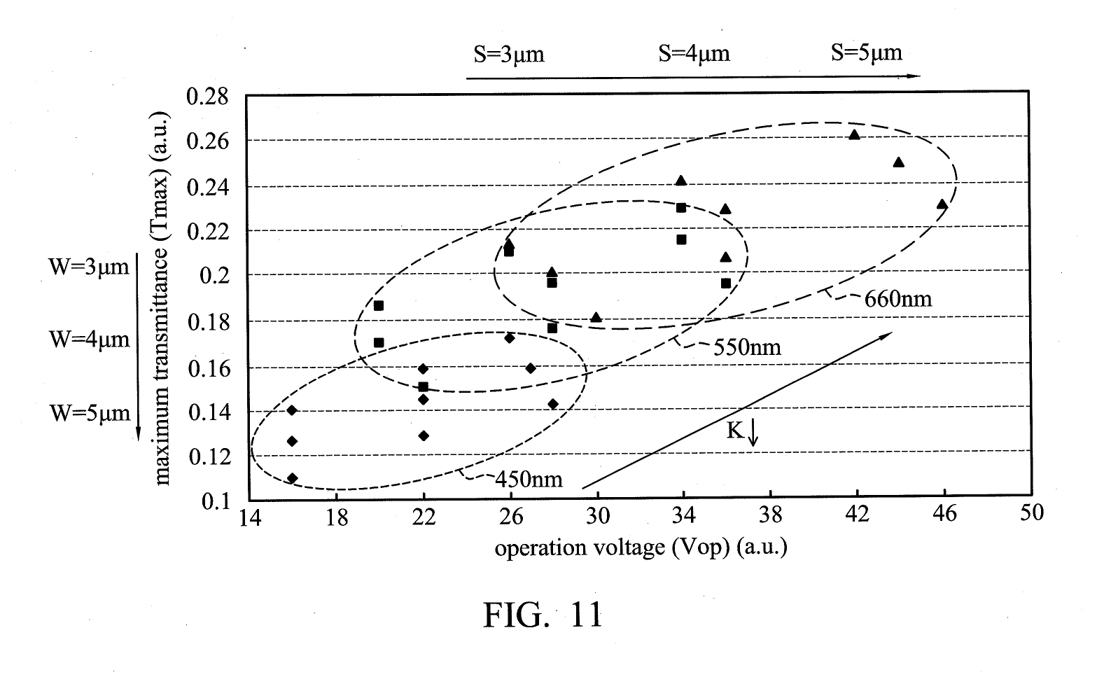

FIG. 11 is an operation voltage (Vop)-maximum transmittance (Tmax) comparison of BPLC display devices according to various exemplary embodiments of the invention. FIG. 11 shows the relationship between the operation voltage (Vop)-maximum transmittance (Tmax) and the various electrode widths or electrode slits of sub-pixel areas, which allow lights of various main wavelengths transmitting therethrough, of the display devices while the cell gap (d) is fixed as 5 μm and the electrode height (H) is fixed as 3 μm. In FIG. 11, data points of the blue sub-pixel areas (diamond-shaped point) of the various display devices may be surrounded by a single dotted circle. Also, data points of the green sub-pixel areas (square point) of the various display devices may be surrounded by another single dotted circle. Further, data points of the red sub-pixel areas (triangular-shaped point) of the various display devices may be surrounded by yet another single dotted circle. Additionally, varied values of the electrode width (W) of the blue, green and blue sub-pixel areas may be 3 μm, 4 μm and 5 μm. Also, varied values of the electrode slit (S) of the blue, green and blue sub-pixel areas may be 3 μm, 4 μm and 5 μm. From the trend of the operation voltage (Vop)-maximum transmittance (Tmax) as shown in FIG. 11, it is shown that when a light of a main wavelength allowed transmitting the sub-pixel area is increased, the corresponding operation voltage (Vop) and the corresponding maximum transmittance (Tmax) have increasing trends.

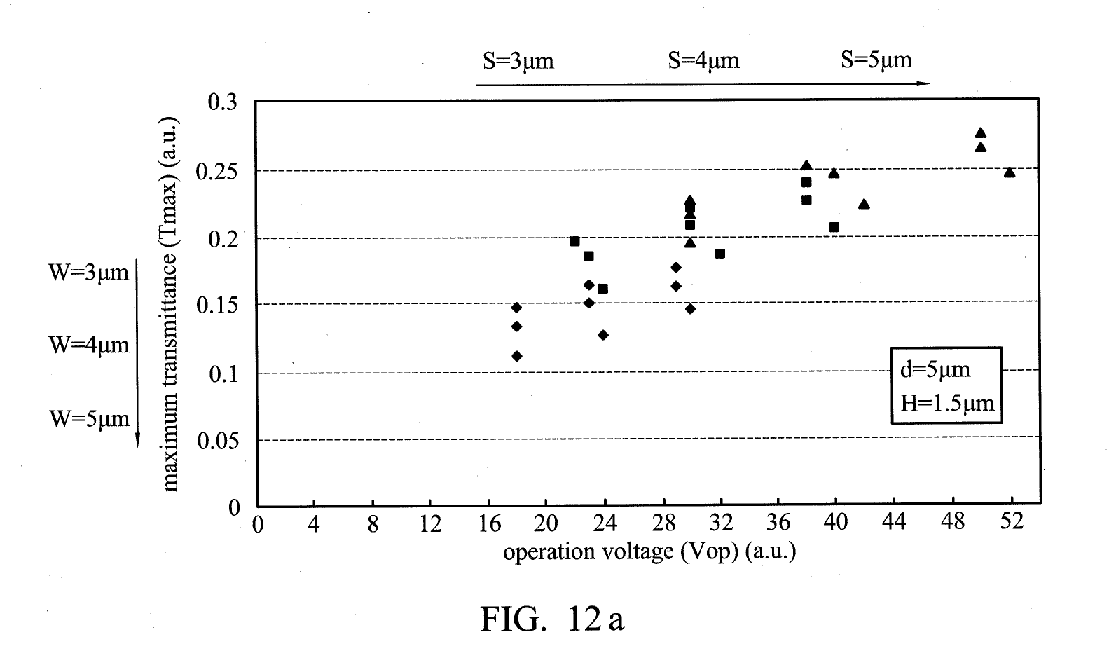

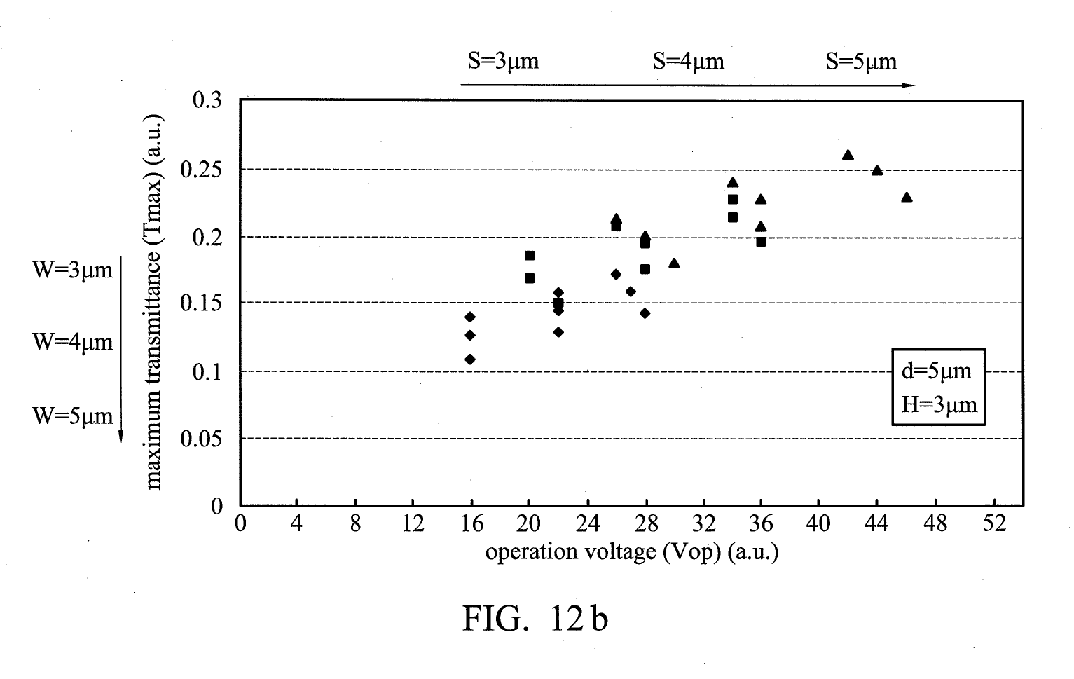

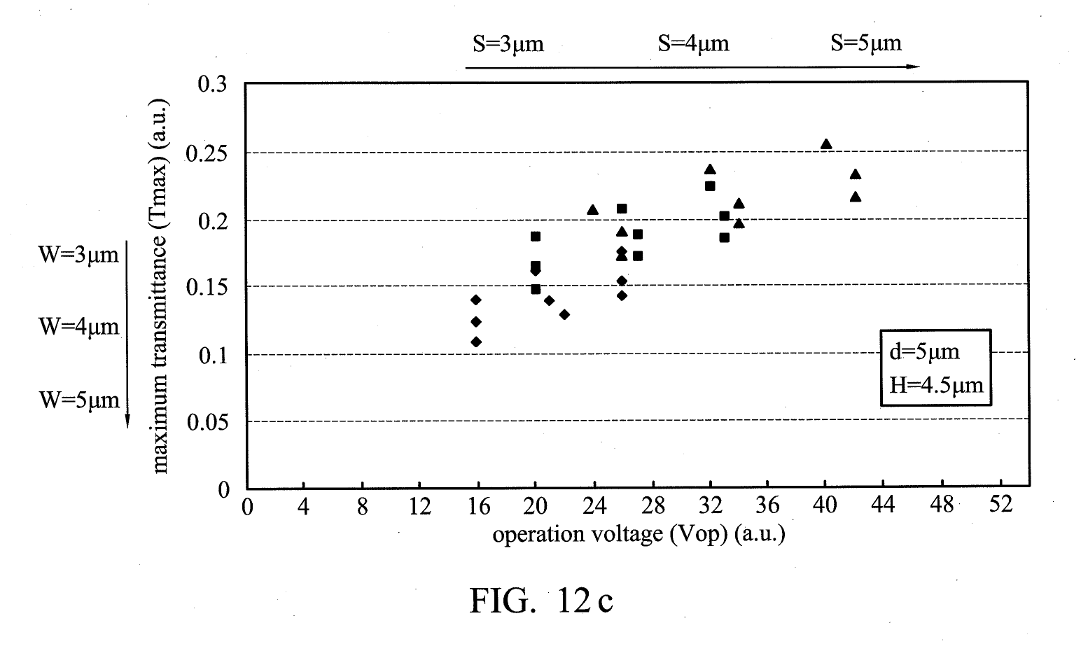

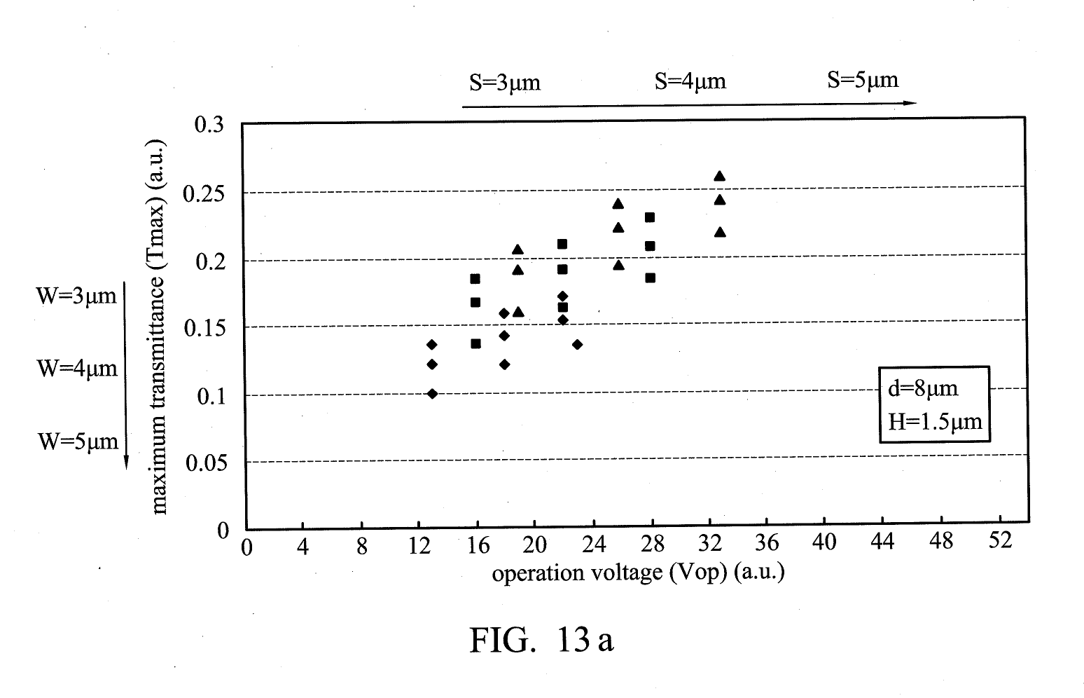

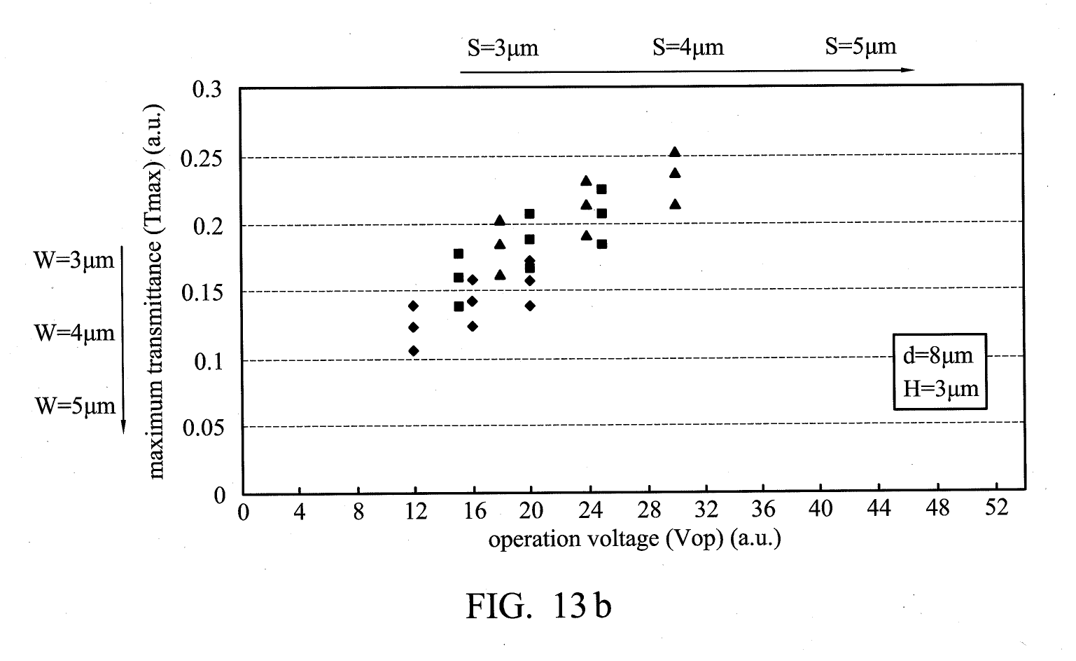

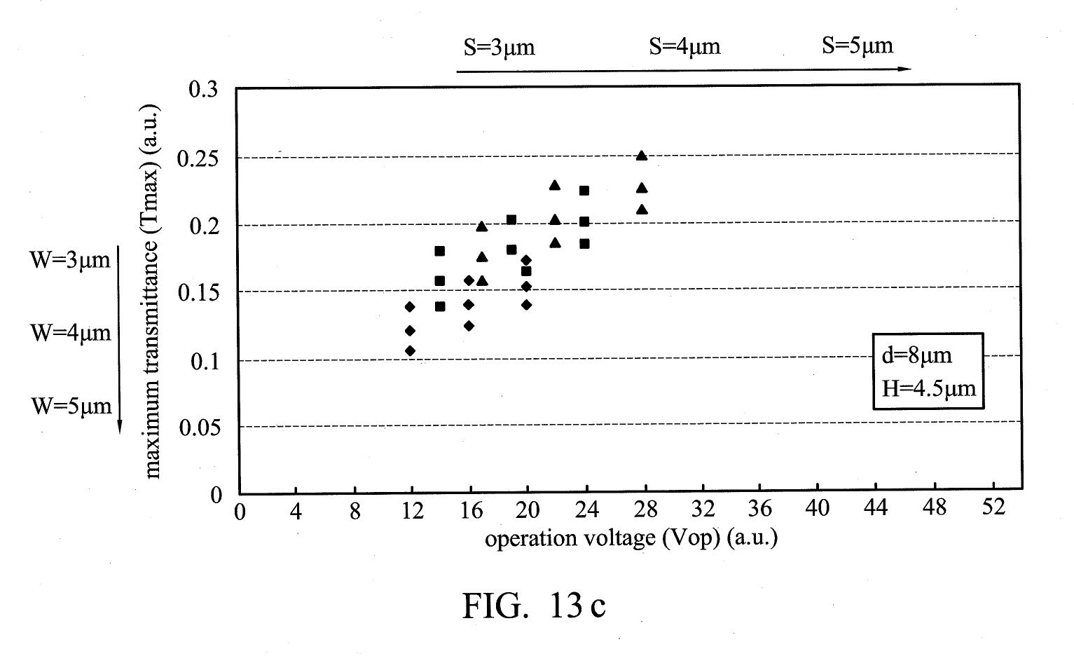

FIGS. 12a to 12c are operation voltage (Vop)-maximum transmittance (Tmax) comparisons of BPLC display devices according to various exemplary embodiments of the invention. Also, FIGS. 12a to 12c respectively show the relationship between the operation voltage (Vop)-maximum transmittance (Tmax) and the various electrode widths or electrode slits of sub-pixel areas, which allow lights of various main wavelengths transmitting therethrough, of the display devices in different electrode height (H) (1.5 μm, 3 μm and 4.5 μm) while the cell gap (d) are fixed as 5 μm. Further, FIGS. 13a to 13c are operation voltage (Vop)-maximum transmittance (Tmax) comparisons of BPLC display devices according to various exemplary embodiments of the invention. Also, FIGS. 13a to 13c respectively show the relationship between the operation voltage (Vop)-maximum transmittance (Tmax) and the various electrode widths or electrode slits of sub-pixel areas, which allow lights of various main wavelengths transmitting therethrough, of the display devices in different electrode height (H) (1.5 μm, 3 μm and 4.5 μm) while the cell gap (d) are fixed as 8 μm. Additionally, in FIGS. 12a to 12c and 13a to 13c, varied values of the electrode width (W) of the blue, green and blue sub-pixel areas may be 3 μm, 4 μm and 5 μm. Also, varied values of the electrode slit (S) of the blue, green and blue sub-pixel areas may be 3 μm, 4 μm and 5 μm. From the trend of the operation voltage (Vop)-maximum transmittance (Tmax) as shown in FIGS. 12a to 12c and 13a to 13c, it is shown that when the electrode height (H) is increased, the corresponding operation voltage (Vop) has a decreasing trend, but the change of the corresponding maximum transmittance (Tmax) is not obvious.

From the results of FIGS. 10, 11, 12a to 12c and 13a to 13c, it is shown that when the ratio of the electrode width to the electrode slit of the different sub-pixel areas of the BPLC display device are substantially the same as each other, the corresponding maximum transmittance (Tmax) are substantially the same as each other. Also, when the main wavelength of a light allowed transmitting through the sub-pixel area is increased, the corresponding operation voltage (Vop) and the corresponding maximum transmittance (Tmax) have increasing trends. Further, when the electrode height (H) decreases, the Vop has an increasing trend. Therefore, in another embodiment, the electrode of the sub-pixel area of the BPLC display device may be designed to satisfy Equations (1) and (5), Equations (1), (2) and (5), Equations (1), (3) and (5), Equations (1), (4) and (5), Equations (1), (2), (4) and (5), Equations (1), (3), (4) and (5), or Equations (1)-(5).

(H1)>(H2)>(H3) Equation (5)

, wherein H1, H2 and H3 are respectively electrode heights of the first (red) sub-pixel area, the second (green) sub-pixel area and the third (blue) sub-pixel area of a BPLC display device according to another exemplary embodiment of the invention.

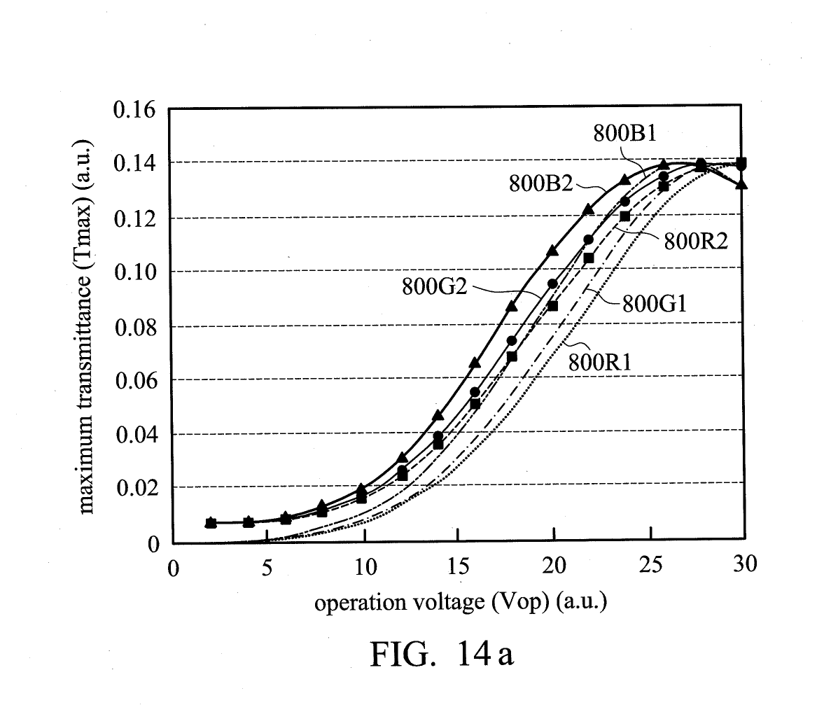

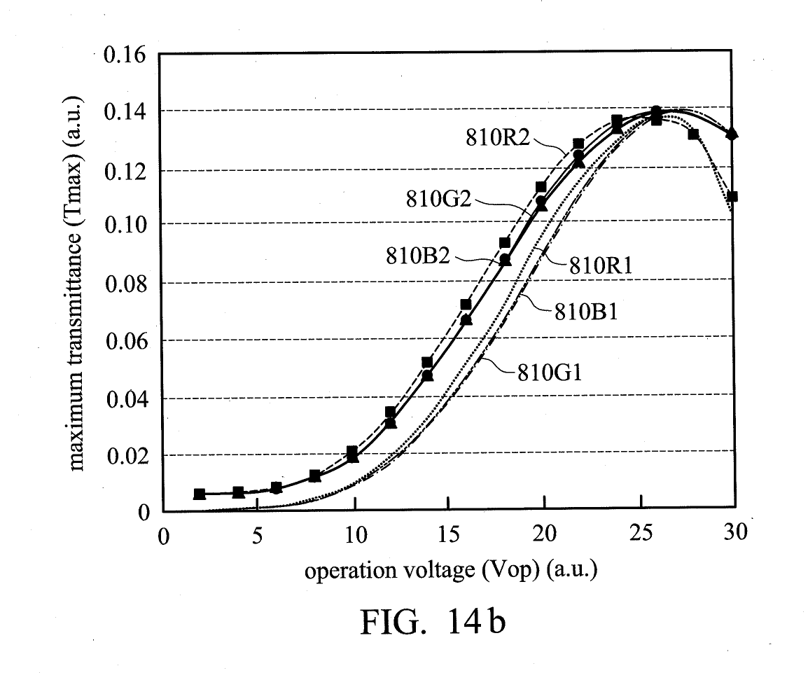

In the BPLC display device according to one exemplary embodiment of the invention, the sub-pixel area allowing a light of a longer main wavelength transmitting therethrough needs to be designed to have a larger cell gap. Additionally, designs of the electrode width, the electrode slit and the cell gap of the sub-pixel areas can be applied in the display device 200b as shown in FIGS. 14a and 14b.

FIGS. 14a and 14b are operation voltage-transmittance curve diagrams corresponding to the conventional BPLC display device and a BPLC display device according to one exemplary embodiment of the invention, wherein the various sub-pixel areas have different ratios of the electrode width to the electrode slit, at 45-degree and 90-degree viewing-angles. The conventional BPLC display device and a BPLC display device according to one exemplary embodiment of the invention as shown in FIGS. 14a and 14b use the liquid crystal used in Physical Review E 83, 041706 (2011) as the BPLC layer, and use the display device 200a as shown in FIGS. 2a and 2b as the display device structure. Red, green and blue sub-pixel areas of the conventional BPLC display device as shown in FIG. 14a have a fixed electrode slit (S=5 μm), electrode width (W=5 μm) and cell gap (d=3.9 μm). Electrode slits of red, green and blue sub-pixel areas of the BPLC display device as shown FIG. 14b are respectively 4 μm, 4.5 μm and 5 μm. Also, electrode widths of the red, green and blue sub-pixel areas of the BPLC display device as shown FIG. 14b are respectively 4 μm, 4.75 μm and 5 μm. Further, cell gaps of the red, green and blue sub-pixel areas of the BPLC display device are fixed as 3.9 μm. As shown in FIGS. 14a and 14b, overlapping degrees of the red sub-pixel area (810R1 and 810R2), green sub-pixel area (810G1 and 810G2) and blue sub-pixel area (810B1 and 810B2) of the BPLC display device are better than that of the red sub-pixel area (800R1 and 800R2), green sub-pixel area (800G1 and 800G2) and blue sub-pixel area (800B1 and 800B2) of the conventional BPLC display device at 45-degree and 90-degree viewing-angles. Accordingly, a BPLC display device according to one exemplary embodiment of the invention has an improved dispersion performance at 45-degree and 90-degree viewing-angle.

Embodiments provide a display device. Different sub-pixel areas of the display device have different designs of the electrode width, electrode slit and/or cell gap, so that the sub-pixel area allowing a light of a smaller main wavelength transmitting therethrough can substantially fully overlap with the sub-pixel area allowing a light of a larger main wavelength transmitting therethrough. Therefore, the dispersion effect occurring in the sub-pixel area allowing a light of a smaller main wavelength transmitting therethrough of the conventional display device can be reduced. The display device may be also used as a fringe field switching (FFS) BPLC display device.

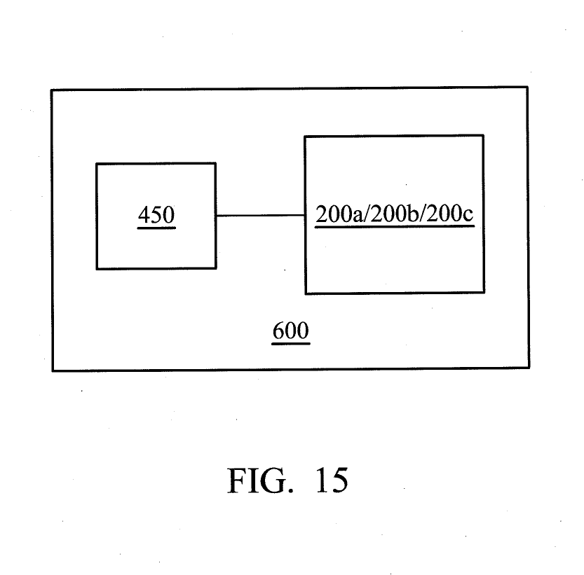

FIG. 15 schematically shows an arrangement of an electronic device 600 comprising one exemplary embodiment of a display device of the invention. In this embodiment, the electronic device 600 may be applied to a mobile phone, digital camera, personal digital assistant (PDA), notebook computer, desktop computer, television, car display or portable DVD player. The electronic device 600 may comprise a display device 200a, 200b or 200c (shown in FIGS. 2a, 2b, 3a and 7e) and a controller 450 controlling the display device 200a, 200b or 200c such that the display device displays images.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device, comprising:
a first sub-pixel area allowing a light of a first main wavelength transmitting therethrough;
a second sub-pixel area allowing a light of a second main wavelength transmitting therethrough;
a third sub-pixel area allowing a light of a third main wavelength transmitting therethrough;
a first interdigitated electrode disposed in the first sub-pixel area, having first electrode strips parallel to each other, wherein the first electrode strips have a first electrode width and a first electrode slit, and wherein the first sub-pixel area has a first ratio of the first electrode width to the first electrode slit of the first electrode strips;
a second interdigitated electrode disposed in the second sub-pixel area, having second electrode strips parallel to each other, wherein the second electrode strips have a second electrode width and a second electrode slit, and wherein the second sub-pixel area has a second ratio of the second electrode width to the second electrode slit of the second electrode strips; and
a third interdigitated electrode disposed in the third sub-pixel area, having third electrode strips parallel to each other, wherein the third electrode strips have a third electrode width and a third electrode slit, and wherein the third sub-pixel area has a third ratio of the third electrode width to the third electrode slit of the third electrode strips,
wherein when the first main wavelength is larger than the second main wavelength and the second main wavelength is larger than the third main wavelength, a difference between any two of the first, second and third ratios is less than 0.2, and
wherein the first electrode slit is smaller than the second electrode slit, and the second electrode slit is smaller than the third electrode slit.

2. The display device as claimed in claim 1, further comprising:
a blue phase liquid crystal layer covering the first, second and third sub-pixel areas.

3. The display device as claimed in claim 1, wherein the first sub-pixel area has a first cell gap, the second sub-pixel area has a second cell gap, the third sub-pixel area has a third cell gap, and wherein the first cell gap is larger than the second cell gap and the second cell gap is larger than third cell gap.

4. The display device as claimed in claim 2, wherein the first main wavelength is 650±30 nm, the second main wavelength is 550±30 nm, and the third main wavelength is 450±30 nm.

5. The display device as claimed in claim 1, wherein the first, second and third electrode strips respectively have a first, second and third electrode heights, and wherein the first electrode height is larger than the second electrode height and the second electrode height is larger than the third electrode height.

6. A display device, comprising:
a first sub-pixel area allowing a light of a first main wavelength transmitting therethrough having a first cell gap;
a second sub-pixel area allowing a light of a second main wavelength transmitting therethrough having a second cell gap;
a third sub-pixel area allowing a light of a third main wavelength transmitting therethrough having a third cell gap;
a first interdigitated electrode disposed in the first sub-pixel area, having first electrode strips parallel to each other, wherein the first electrode strips have a first electrode width and a first electrode slit, and wherein the first sub-pixel area has a first ratio of the first electrode width to the first electrode slit of the first electrode strips;
a second interdigitated electrode disposed in the second sub-pixel area, having second electrode strips parallel to each other, wherein the second electrode strips have a second electrode width and a second electrode slit, and wherein the second sub-pixel area has a second ratio of the second electrode width to the second electrode slit of the second electrode strips; and
a third interdigitated electrode disposed in the third sub-pixel area, having third electrode strips parallel to each other, wherein the third electrode strips have a third electrode width and a third electrode slit, and wherein the third sub-pixel area has a third ratio of the third electrode width to the third electrode slit of the third electrode strips,
wherein when the first main wavelength is larger than the second main wavelength and the second main wavelength is larger than the third main wavelength, a difference between any two of the first, second and third ratios is less than 0.2, and
wherein the first cell gap is larger than the second cell gap and the second cell gap is larger than third cell gap.

7. The display device as claimed in claim 6, further comprising:
a blue phase liquid crystal layer covering the first, second and third sub-pixel areas.

8. The display device as claimed in claim 6, wherein the first electrode slit is smaller than the second electrode slit, and the second electrode slit is smaller than the third electrode slit.

9. The display device as claimed in claim 6, wherein the first main wavelength is 650±30 nm, the second main wavelength is 550±30 nm, and the third main wavelength is 450±30 nm.

10. The display device as claimed in claim 6, wherein the first, second and third electrode strips respectively have a first, second and third electrode heights, and wherein the first electrode height is larger than the second electrode height and the second electrode height is larger than the third electrode height.

11. A display device, comprising:
a first sub-pixel area allowing a light of a first main wavelength transmitting therethrough;
a second sub-pixel area allowing a light of a second main wavelength transmitting therethrough;
a third sub-pixel area allowing a light of a third main wavelength transmitting therethrough;
a first interdigitated electrode disposed in the first sub-pixel area, having first electrode strips parallel to each other, wherein the first electrode strips have a first electrode width, a first electrode slit and a first electrode height, and wherein the first sub-pixel area has a first ratio of the first electrode width to the first electrode slit of the first electrode strips;
a second interdigitated electrode disposed in the second sub-pixel area, having second electrode strips parallel to each other, wherein the second electrode strips have a second electrode width, a second electrode slit and a second electrode height, and wherein the second sub-pixel area has a second ratio of the second electrode width to the second electrode slit of the second electrode strips; and
a third interdigitated electrode disposed in the third sub-pixel area, having third electrode strips parallel to each other, wherein the third electrode strips have a third electrode width, a third electrode slit and a third electrode height, and wherein the third sub-pixel area has a third ratio of the third electrode width to the third electrode slit of the third electrode strips,
wherein when the first main wavelength is larger than the second main wavelength and the second main wavelength is larger than the third main wavelength, a difference between any two of the first, second and third ratios is less than 0.2, and
wherein the first electrode height is larger than the second electrode height and the second electrode height is larger than third electrode height.

12. The display device as claimed in claim 11, further comprising:
a blue phase liquid crystal layer covering the first, second and third sub-pixel areas.

13. The display device as claimed in claim 11, wherein the first electrode slit is smaller than the second electrode slit, and the second electrode slit is smaller than the third electrode slit.

14. The display device as claimed in claim 11, wherein the first sub-pixel area has a first cell gap, the second sub-pixel area has a second cell gap, the third sub-pixel area has a third cell gap, and wherein the first cell gap is larger than the second cell gap and the second cell gap is larger than third cell gap.

15. An electronic device, comprising
a display device as claimed in claim 1; and
a controller controlling the display device such that the display device displays images.

16. The display device as claimed in claim 15, wherein the electronic device is a mobile phone, digital camera, personal digital assistant (PDA), notebook computer, desktop computer, television, car display or portable DVD player.

17. An electronic device, comprising
a display device as claimed in claim 6; and
a controller controlling the display device such that the display device displays images.

18. The display device as claimed in claim 17, wherein the electronic device is a mobile phone, digital camera, personal digital assistant (PDA), notebook computer, desktop computer, television, car display or portable DVD player.
